(19) United States
(12) Patent Application Publication
(10) Pub. No.: US 2006/0122856 A1
(43) Pub. Date: Jun. 8, 2006

(54) System and method for enabling consumers to add personal charitable contributions and transfer the right to designate a beneficiary to other consumers

(75) Inventors: Turnstall Perry Rushton, Atlanta, GA (US); Clare Moss Thomas, Alpharetta, GA (US); Lorine Marie Giberti, Atlanta, GA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Benevolink Corporation, Atlanta, GA (US)

(21) Appl. No.: 11/029,669

(22) Filed: Jan. 6, 2005

Related U.S. Application Data
(63) Continuation-in-part of application No. 10/456,286, filed on Jun. 6, 2003.
(60) Provisional application No. 60/386,613, filed on Jun. 6, 2002.

(51) Int. Cl. G06Q 99/00

(52) U.S. Cl. 705/1

(57) ABSTRACT

A method for enabling registered consumers to direct matching charitable contributions donated by a plurality of program partners to a plurality of designated beneficiaries through a directed giving service provider based on consumer purchases during a predetermined purchase period. The method also enables registered consumers to donate their own funds, and to transfer their direction rights to at least one other consumer and/or consumer account. Program partners can include individual retail stores, retail store chains, credit providers and product manufacturers conducting business either at a physical location, by telephone, direct mail, or online via a web site, etc. The directing rights generated by purchases of qualified products for all registered consumers are aggregated by the directed giving service provider and individual estimates of amounts to be directed to designated beneficiaries are provided to individual consumers to enable them to allocate contribution percentages to each selected beneficiary. A directed giving service provider or charitable foundation receives funds from the program partners on a regular basis and sends those funds to the beneficiaries chosen by the consumers on a regular basis. The directed giving service provider establishes standards for beneficiary qualification and works to ensure that payments are made only to those beneficiaries meeting such standards.

### CROSS-REFERENCE TO RELATED APPLICATION

The present patent application is a continuation-in-part of a previously filed utility patent application entitled “Method For Enabling Consumers To Direct Corporate Charitable Contributions Through Aggregated Purchase Decisions,” filed Jun. 6, 2003, as U.S. patent application Ser. No. 10/456,286, which is a formalization of a previously filed provisional patent application entitled “Method for Enabling Consumers to Direct Corporate Charitable Contributions through Aggregated Purchase Decisions”, filed Jun. 6, 2002, as U.S. Patent Application Ser. No. 60/386,613 by the inventors named in this patent application. This patent application claims the benefit of the filing dates of the cited utility and provisional patent applications according to the statutes and rules governing utility and provisional patent applications, particularly 35 USC § 119 and 37 CFR § § 1.789. The specification and drawings of the utility and provisional patent applications are specifically incorporated herein by reference.

### FIELD OF THE INVENTION

The present invention is directed to methods for enabling consumers to affect corporate governance, and more specifically, to methods that enable consumers to direct corporate charitable contributions through the aggregated directing rights generated by purchase decisions of multiple consumers.

### BACKGROUND OF THE INVENTION

Personal rewards programs and charitable giving programs compete for consumer and program partner attention by offering different types of personal benefits to consumers based on purchases. Traditional rewards programs reward consumers with points based on purchases through program partners. Partners are usually restricted to retailers, as the programs do not have tracking technology for branded consumer goods purchases. Charitable giving programs typically enable consumers who have purchased products from participating retailers to earn contribution points or funds that individual consumers can direct to pre-chosen charities.

There is a need for a method of and a system for, over pre-determined, distinct time periods, (1) tracking qualifying purchases of products and services by participating consumers and from participating program partners (manufacturers, service providers, retailers, and credit providers), (2) aggregating, on behalf of each such consumer, the pre-determined directing rights generated by and unique to each such purchase, (3) allocating such directing rights to charities selected by each individual consumer, each such allocation to be the aggregate of all such directing rights directed by all consumers to the specific charity; (4) allowing each participating consumer to contribute his or her own funds to a specific charity(ies) in addition to or as part of the predetermined directing rights; and (5) allowing each participating consumer to transfer his or her directing rights to one or more consumer account(s), wherein such transferred directing rights may have different and/or other restrictions than a consumer's own personal directing rights.

### SUMMARY OF THE INVENTION

The present invention unites the consumer, the program partners and charitable organizations in a mutually beneficial relationship by providing a program that aggregates over time directing rights generated by multiple consumer purchases from and through multiple program partners into a single fund that can be distributed to the charity or charities chosen by the consumer. The present invention provides a mechanism that creates or establishes: (1) a method for consumers to donate their own funds and/or funds provided by multiple program partners to charitable organizations of their choice; (2) a mechanism for charitable organizations to perform fundraising activities; (3) a cause-related loyalty marketing service and a charitable giving service for program partners; (4) a concept of consumer-directed corporate giving; and (5) a method for consumers to delegate or transfer their own directing rights, such as to other consumer account(s), for example.

Each of the constituent groups benefits from the present invention. Charitable organizations receive benefits in that they (1) receive incremental charitable contributions, and (2) access a new method of fundraising through existing donors. Consumers receive benefits in that they (1) are enabled to increase charitable giving with or without making additional personal payments; (2) are given a powerful voice in corporate governance; and (3) are enabled to delegate and/or transfer their accumulated directing rights to one or more other consumer accounts. Program partners receive benefits in that they (1) can decrease or divert advertising and marketing budgets, (2) foster brand loyalty, (3) improve corporate image by re-establishing consumer trust and demonstrating corporate accountability, (4) create an efficient and effective method of localizing corporate giving, and (5) tap into the marketing efforts of over two million non-profit entities in the United States, most of which never have had access to corporate funds.

A registered consumer earns rights to direct program partner funds (and/or contribute his or her own funds) to his or her favorite cause(s) by buying products and services from program partners and/or by making a direct contribution. Consumers are empowered to direct these funds to any verifiable charitable cause, and/or to transfer directing rights to another consumer account, for example, the owner of which may direct the funds to any verifiable charitable cause of his or her choosing, or transfer the directing rights to yet another consumer account. This may include, but is not limited to, any beneficiary organizations or programs that are operated exclusively for charitable, religious, educational, scientific, literary, or other causes considered charitable for the purposes of tax-exemption as defined by IRS Publication 526. The invention enables program partners to contribute to the fund based upon tracked purchases of registered consumers using a variety of possible calculation methods. These may include, but are not limited to, a stated percentage of consumer purchases, a flat fee per unit purchased, or a fixed amount to be shared equally across all purchases for a defined time period, either by purchase value or by unit. These product donation rules may be different over different promotional time periods, and may be subject to various maximum and minimum rules as set by the program partner. The individual consumer registers with a directed giving service provider (DGSP) through a toll free telephone number, electronically through the Internet, or via some other approved communication method. The consumer provides basic registration information such as his name and address and the numbers or identifiers for any trackable methods of purchase, which may include credit card numbers, account numbers, and loyalty card numbers (such as the ones provided by supermarkets, video stores, or pharmacies) that he wishes to include in the program. The more trackable methods the consumer provides when registering with the DGSP, the greater the potential giving rights that will be generated. Tracking of this information may be done by the DGSP or by a third-party proxy server, such as aggregator services, for example. The invention enables each consumer to choose from a database of eligible beneficiary organizations or nominated beneficiaries to add (e.g. beneficiaries added after qualification period) and direct that his funds be disbursed across those beneficiary organizations in the percentages he chooses. The invention aggregates the directing decisions of all consumers and sends single periodic payments to each beneficiary organization.

According to various other embodiments, consumers may also contribute their own funds through the charitable giving service, either in addition to funds provided by (i.e. collected from) the program partners or as a separate contribution(s). In still other embodiments, the systems and methods described herein may be used to enable consumers to donate (or give as a gift) their accumulated rights to direct funds (including their own funds), for example, to at least one other consumer account, designated or anonymous, the holder of which may then in turn contribute such credits or funds to the designated beneficiaries of his or her choosing, or transfer such directing rights to still another consumer account. The process of donating rights to direct funds may continue until the funds are finally donated to a particular beneficiary(ies) or charity(ies).

According to one embodiment of the invention, a method for accumulating charitable contributions is provided. The method comprising: determining a first portion of a charitable contribution based on a purchase history of at least one consumer; receiving from at least one program partner the first portion of the charitable contribution; and receiving from a first consumer a second portion of the charitable contribution.

According to one embodiment of the invention, a system for accumulating charitable contributions is provided. The system comprising: first portion determination means for determining a first portion of a charitable contribution based on a purchase history of at least one consumer; program partner reception means for receiving from at least one program partner the first portion of the charitable contribution; and consumer reception means for receiving from a first consumer a second portion of the charitable contribution.

In another embodiment of the invention, a system for directing charitable contributions to at least one beneficiary is provided. The system comprising: selection means for allowing at least one consumer to select at least one beneficiary; amount determination means for determining at least one charitable contribution amount to be directed to the selected at least one beneficiary, the at least one charitable contribution amount being based on consumer product purchase information relating to the at least one consumer; and contribution means for allowing the at least one consumer to contribute at least one consumer contribution amount to be directed to at least the at least one beneficiary.

In yet another embodiment of the invention, a method for donating or transferring charitable contribution directing rights is provided. The method comprising: receiving an instruction from a first consumer to transfer to a consumer account certain charitable contribution directing rights earned as a result of at least one consumer's purchase history, the charitable contribution directing rights comprising rights to direct payment and/or donation of at least one charitable contribution contributed by at least one program partner; and transferring the charitable contribution direction rights to the consumer account.

According to another embodiment of the invention, a system for donating or transferring charitable contributions is provided. The system comprising: directing means for receiving an instruction from a first consumer to transfer to a second consumer account certain charitable contribution direction rights earned as a result of at least one consumer's purchase history, the charitable contribution direction rights comprising rights to direct payment and/or donation of at least one charitable contribution contributed by at least one program partner; and transferring means for transferring the charitable contribution directing rights to the consumer account.

In still another embodiment of the invention, a method for paying charitable contributions is provided. The method comprising: providing a first portion of a charitable contribution; and directing payment of the first portion and a second portion of the charitable contribution to at least one beneficiary, the second portion being contributed by at least one program partner based on a purchase history of at least one consumer.

In still another embodiment of the invention, a system for paying charitable contributions is provided. The system comprising: provider means for providing a first portion of a charitable contribution; and directing means for directing payment of the first portion and a second portion of the charitable contribution to at least one beneficiary, the second portion being contributed by at least one program partner based on a purchase history of at least one consumer.

In another embodiment of the invention, a method for paying charitable contributions is provided. The method comprising: receiving a first portion of a charitable contribution from at least one program partner, the first portion being based on a purchase history of at least one consumer; receiving a second portion of the charitable contribution from at least one consumer; and paying the first portion and second portion of the charitable contribution to at least one beneficiary, the at least one beneficiary being selected by at least one consumer.

In another embodiment of the invention, a system for paying charitable contributions is provided. The system comprising: first portion reception means for receiving a first portion of a charitable contribution from at least one program partner, the first portion being based on a purchase history of at least one consumer; second portion reception means for receiving a second portion of the charitable contribution from at least one consumer; and payment means for paying the first portion and second portion of the charitable contribution to at least one beneficiary, the at least one beneficiary being selected by at least one consumer.

In still another embodiment of the invention, a method for directing charitable contributions to at least one beneficiary is provided. The method comprising the steps of: allowing at least one consumer to select at least one beneficiary; determining at least one charitable contribution amount to be directed to the selected at least one beneficiary, the at least one charitable contribution amount being based on consumer product purchase information relating to the at least one consumer; and allowing the at least one consumer to contribute at least one consumer contribution amount to be directed to at least the at least one beneficiary.

In still another embodiment of the invention, a system for directing charitable contributions to at least one beneficiary is provided. The system comprising: beneficiary selection means for allowing at least one consumer to select at least one beneficiary; contribution determination means for determining at least one charitable contribution amount to be directed to the selected at least one beneficiary, the at least one charitable contribution amount being based on consumer product purchase information relating to the at least one consumer; and contribution means for allowing the at least one consumer to contribute at least one consumer contribution amount to be directed to at least the at least one beneficiary.

In yet another embodiment of the invention, a method for making a charitable contribution is provided. The method comprising: receiving a request to provide a first portion of a charitable contribution, the first portion being based on the purchase history of at least one consumer; and providing the first portion to a directed giving service provider, the directed giving service provider paying the first portion to at least one beneficiary along with a second portion of the charitable contribution provider by the at least one consumer.

In yet another embodiment of the invention, a system for making a charitable contribution is provided. The system comprising: request reception means for receiving a request to provide a first portion of a charitable contribution, the first portion being based on the purchase history of at least one consumer; and provider means for providing the first portion to a directed giving service provider, the directed giving service provider paying the first portion to at least one beneficiary along with a second portion of the charitable contribution provider by the at least one consumer.

### DESCRIPTION OF DRAWINGS

The invention is better understood by reading the following detailed description of the invention in conjunction with the accompanying drawings, wherein:

FIGS. 1A-1D illustrate program partner data collected by the directed giving service provider in accordance with an exemplary embodiment of the present invention.

FIGS. 2A-2F illustrate consumer data elements collected by the directed giving service provider in accordance with an exemplary embodiment of the present invention.

FIGS. 3 and 3A illustrate beneficiary data elements collected by the directed giving service provider in accordance with an exemplary embodiment of the present invention.

FIG. 4 illustrates the processing logic for enabling consumers to direct charitable contributions through aggregated purchase decisions.

FIG. 4a illustrates the processing logic for enabling consumers to contribute their own funds as part of directing charitable contributions through aggregated purchase decisions.

FIG. 4b illustrates the processing logic for enabling consumers to contribute their own funds as part of directing charitable contributions.

FIG. 4c illustrates another exemplary processing logic for enabling consumers to contribute their own funds.

FIG. 4d illustrates another exemplary processing logic 450 for enabling consumers to contribute their own funds.

FIG. 4e illustrates a block diagram summarizing one embodiment of the general flow of charitable contributions described herein.

FIG. 4f illustrates an exemplary interface for enabling an administrator of the DGSP to provide parameters relating to the matching of the claimed systems and methods.

FIG. 5 illustrates an overall charitable giving process flow through the directed giving service provider organization in accordance with an exemplary embodiment of the present invention.

FIG. 5a illustrates a portion of a charitable giving process flow through the directed giving service provider organization in accordance with an exemplary embodiment of the present invention.

FIG. 5b illustrates a process flow for contributing or donating charitable contributions donated by at least one program partner.

FIG. 6 illustrates a sample directing period timeline in accordance with an exemplary embodiment of the invention.

FIG. 7 illustrates a client-server based implementation of the directed giving system over a wide area network such as the global Internet.

FIG. 7a is a block diagram illustrating exemplary modules associated with server computer of FIG. 7.

FIG. 7b illustrates one embodiment of a consumer 20, 22, and/or 24 of FIG. 7 having a card reader.

FIG. 8 illustrates a directed service provider web site implementation in accordance with an exemplary embodiment of the invention.

FIGS. 9-9k illustrate various exemplary graphical user interfaces (GUIs) which may enable interaction between a consumer and various embodiments of the systems and methods described herein.

### DETAILED DESCRIPTION OF THE EMBODIMENTS

The following description of the invention is provided as an enabling teaching of the invention and its best, currently known embodiment. Those skilled in the art will recognize that many changes can be made to the embodiments described while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations of the present invention are possible and may even be desirable in certain circumstances and are a part of the present invention. Thus, the following description is provided as illustrative of the principles of the present invention and not in limitation thereof since the scope of the present invention is defined by the claims.

In the context of the present invention, a beneficiary organization is a charitable entity that is qualified to receive funds based upon a pre-determined set of rules established by the DGSP. In the present embodiment, a beneficiary organization must have a valid tax identification number issued by the U.S. Internal Revenue Service (IRS) which will be kept on file by the DGSP, along with other relevant legal and business information. The entity must be determined to be engaging in charitable activities as defined by Section 170(c)(2)(b) of the IRS Code. This invention incorporates the use of a master database of beneficiaries meeting these requirements. There is no written agreement required between the DGSP and any beneficiary organization, although pre-disbursement inquiries will be made by the DGSP and the beneficiary organization will be required to attest to the validity of the taxpayer identification number and other relevant information, if such information is not attainable through other methods. Registered consumers may nominate entities for beneficiary status with the DGSP, however, there will be a temporary period in which the entity's ability to be the recipient of consumer-directed funds will be pending verification and authentication by the DGSP. Once the DGSP has verified the accuracy and validity of pending beneficiary information, the consumer-directed funds will be disbursed by the DGSP.

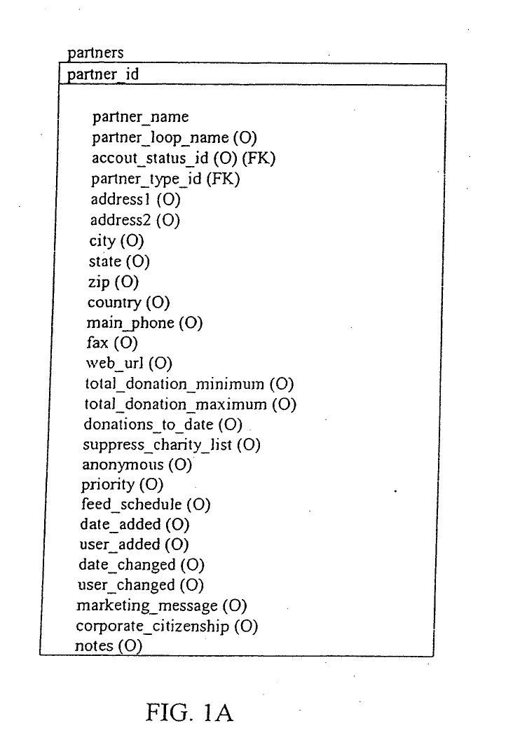

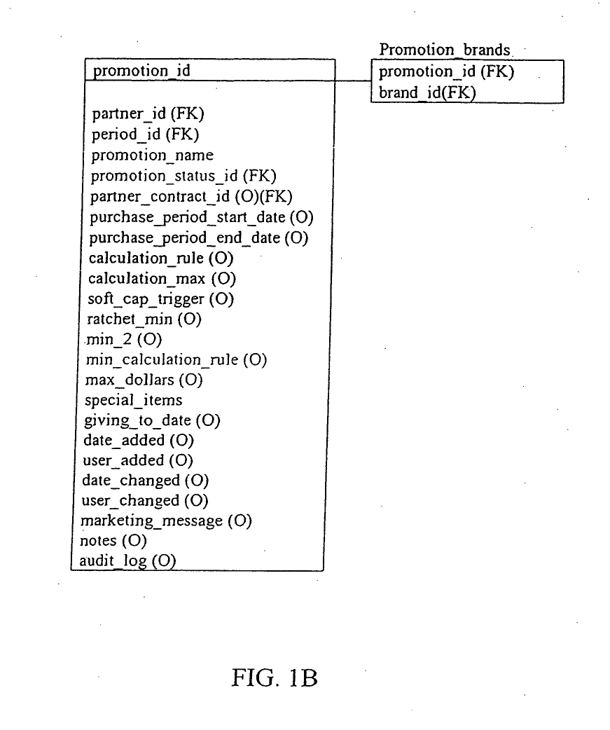

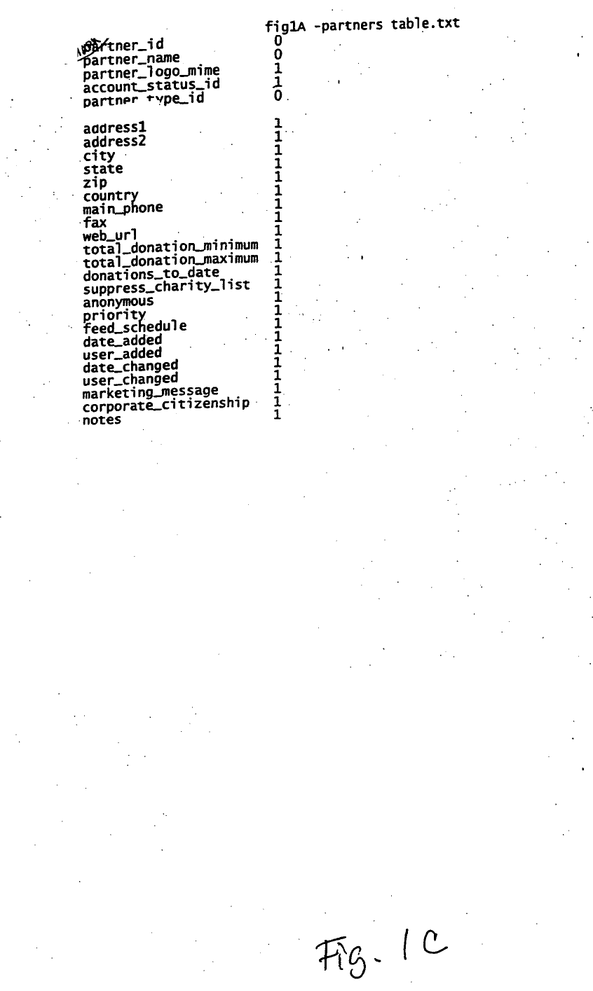

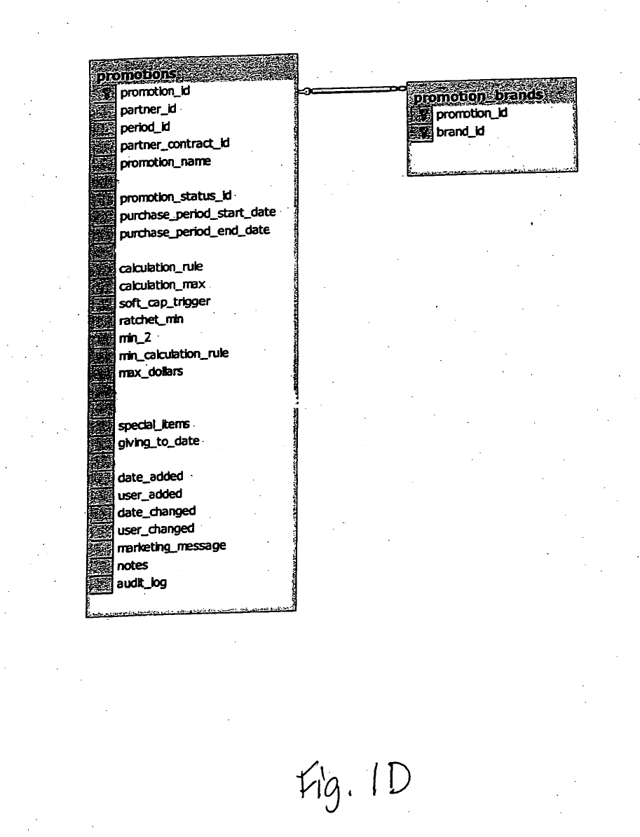

In the present invention, a program partner is a participating corporation or other business entity that has designated specific funds to be directed to beneficiary organizations based upon consumer purchases tracked by the DGSP system. There will be a written agreement required between program partners and the DGSP which governs their respective rights and obligations. Pertinent information concerning each program partner is collected and stored in a product partner file as illustrated in FIGS. 1A and 1C.

In the present invention, a consumer is an individual that is a registered client with the DGSP. Consumers have trackable methods of purchasing and provide tracker information at the time of registration that is updated as needed (e.g., changes in existing data or adding new trackable methods). Consumers can also acquire new trackable methods via the DGSP system. Consumers purchase goods and services from program partners who, in turn, donate funds based on those purchases. Consumers are alerted at regular, pre-determined intervals by the DGSP when it is time to direct their portion of the corporate giving amounts. Consumers designate beneficiary organizations and assign percentages of their giving amount to be allocated to each of their chosen beneficiary organizations.

According to various embodiments of the invention, a program partner may match or contribute funds in several ways, including but not limited to: (1) based on consumer earned designation rights; or (2) based on consumer contributions. In the former, the program partner may match or contribute funds based on a consumer's purchases, for example. In the latter, the program partner may merely match a consumer's contributions. In some embodiments, therefore, matching by program partners may encourage consumers to contribute funds in a general way, or in a more targeted way (e.g., based on consumer's specific purchase or contributions).

A program partner's matching contributions, for example, may be limited or defined by three components: (1) a percentage component, (2) a condition component, and/or (3) a numeric (or cap) component. A percentage component may limit a program partner's contribution to a predetermined percentage of the consumer's contribution(s), for example. A condition component may specifically limit a program partner's contribution based on a predetermined event or occurrence. For example, a program partner may contribute funds only if the consumer purchases a particular product or service (e.g. its own products or services), or only if the consumer contributes funds to a select group, organization, or cause (e.g. American Heart Association). A numeric component (or cap) may limit a program partner's contribution(s) to a particular or predetermined amount. In some embodiments, the matching contributions may be made by an individual or entity other than a program partner.

In the context of the present invention, a product is defined to be any of the following: (1) a specific item with a unique identifier (perhaps a Universal Product Code or an account number); (2) a service offered by a program partner or (3) a retail or other direct-to-consumer transaction as defined by a program partner; or (4) the provision of credit. Program partners designate products that are eligible for fund contributions based on consumer purchases and facilitate the DGSP tracking of consumer purchases of these products.

In the present invention, a product donation rule is the method of calculation used to determine the funds donated based upon consumer purchases. Product donation rules may be based upon any of the following: (1) a stated percentage of consumer purchases; (2) a flat fee per unit purchased; (3) a fixed amount to be shared equally by multiple consumers across all purchases of a specific product, either by purchase value or by unit; (4) any other method of relating consumer purchases to donation amounts. Product donation rules are set by the program partners and may be subject to various maximums and minimums.

In the present invention, a product group promotion is a grouping of products all controlled by a single program partner and defining the terms of the program partner's offer to consumers for contributing to the fund. The product group promotion information includes a listing of the participating products, the product donation rules, and the timing and duration of the promotion. Program partners may have multiple product group promotions. Information is collected on each program partner promotion and stored in a data file as illustrated in FIGS. 1B and 1D.

A purchase period is a predetermined period of time in which consumers buy products and services that are tracked by the DGSP system.

In the present invention, a tracker is any entity that provides information to the DGSP about the specific items purchased by a consumer through trackable methods. There are three types of trackers. The first is a program partner acting as a self-tracker, including retailers. In this case, the program partner sends information about registered consumers' purchases of its participating products directly to the DGSP. Program partners may act as self-trackers for retail sales, direct to consumer e-commerce sales and catalog sales, or other direct-to-consumer sales. The second type of tracker is a third-party tracker. Third-party trackers agree to provide to the DGSP detailed purchase information about sales of a program partner's eligible products or services. The third type of tracker is a consumer providing information for a “special item”, which has verifiable identifiers (such as a VIN) directly to the DGSP, either on-line or through any other appropriate communications method.

Data collection and manipulation are critical elements of the business method described herein. The program partner registration data is entered by a DGSP representative to (1) document the relationship between the program partner and the DGSP; (2) input the product group rules; (3) establish the fund collection and disbursement process; and (4) establish the calculation of fees paid to the DGSP.

The DGSP captures and stores data regarding the various product group promotions from each program partner as illustrated in FIG. 1B. This includes promotion name, partner contract identifier, donation rules and other data.

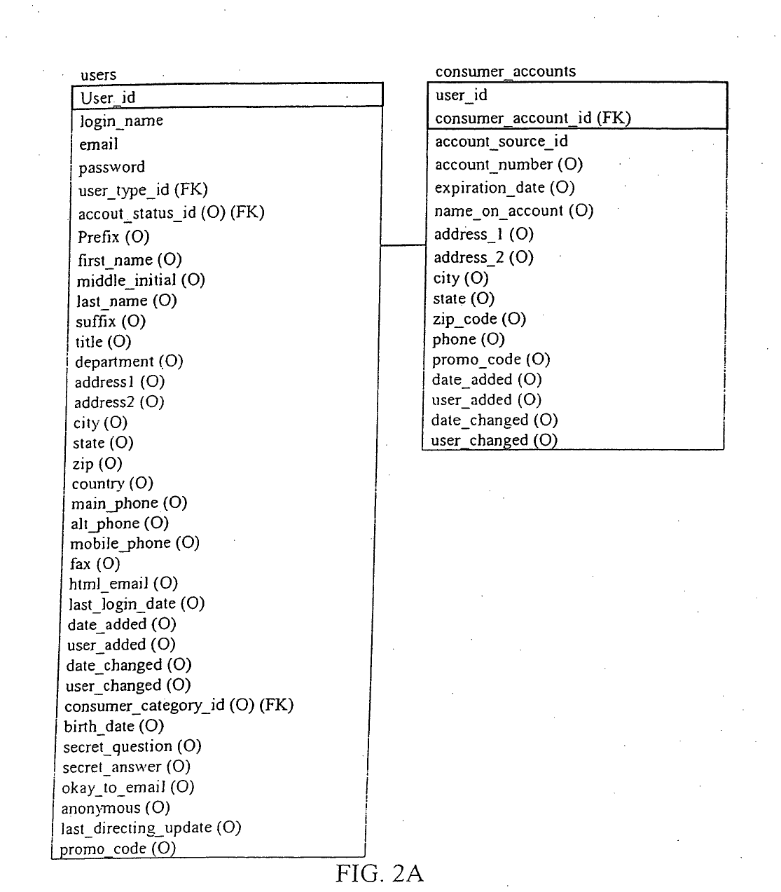

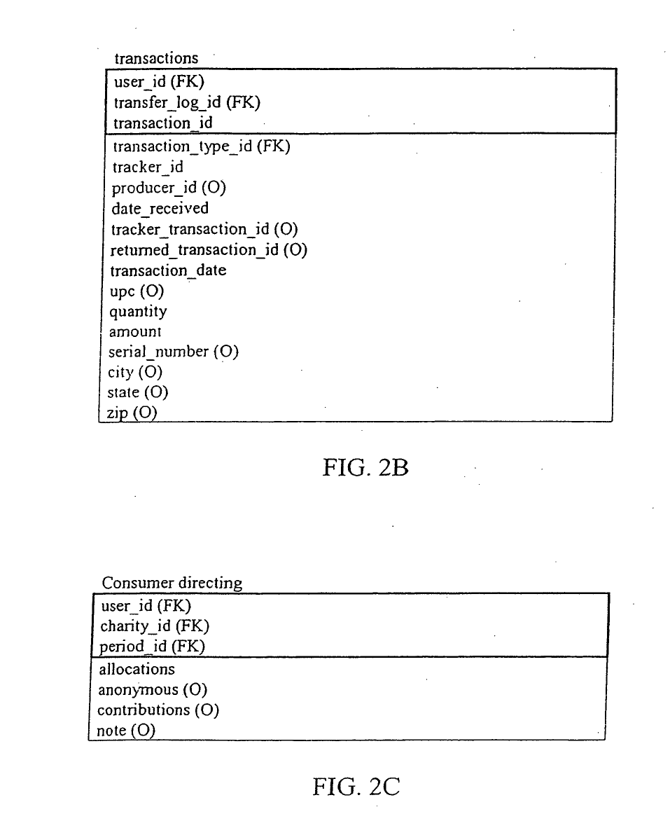

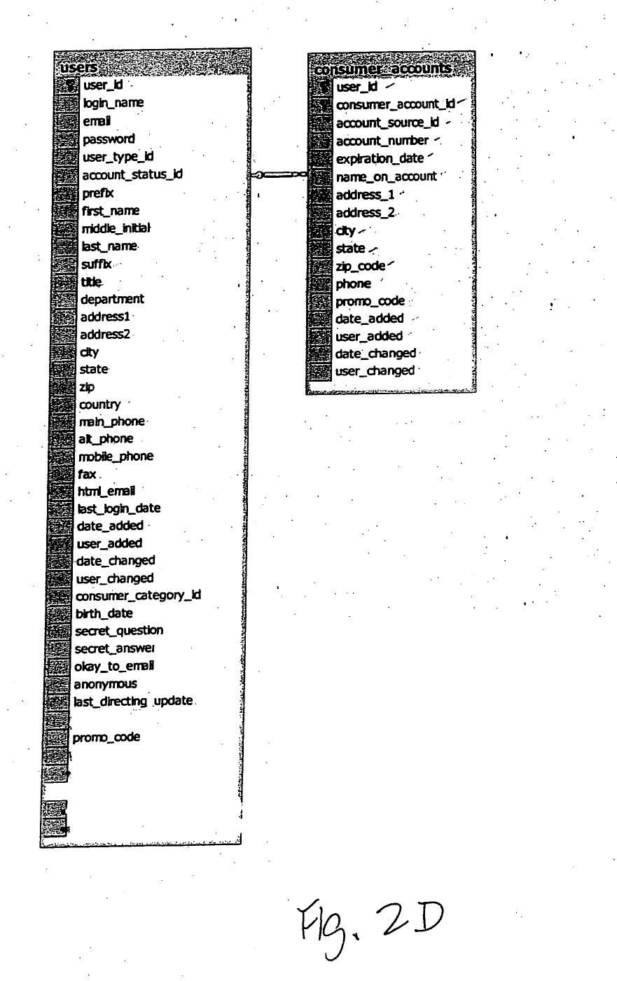

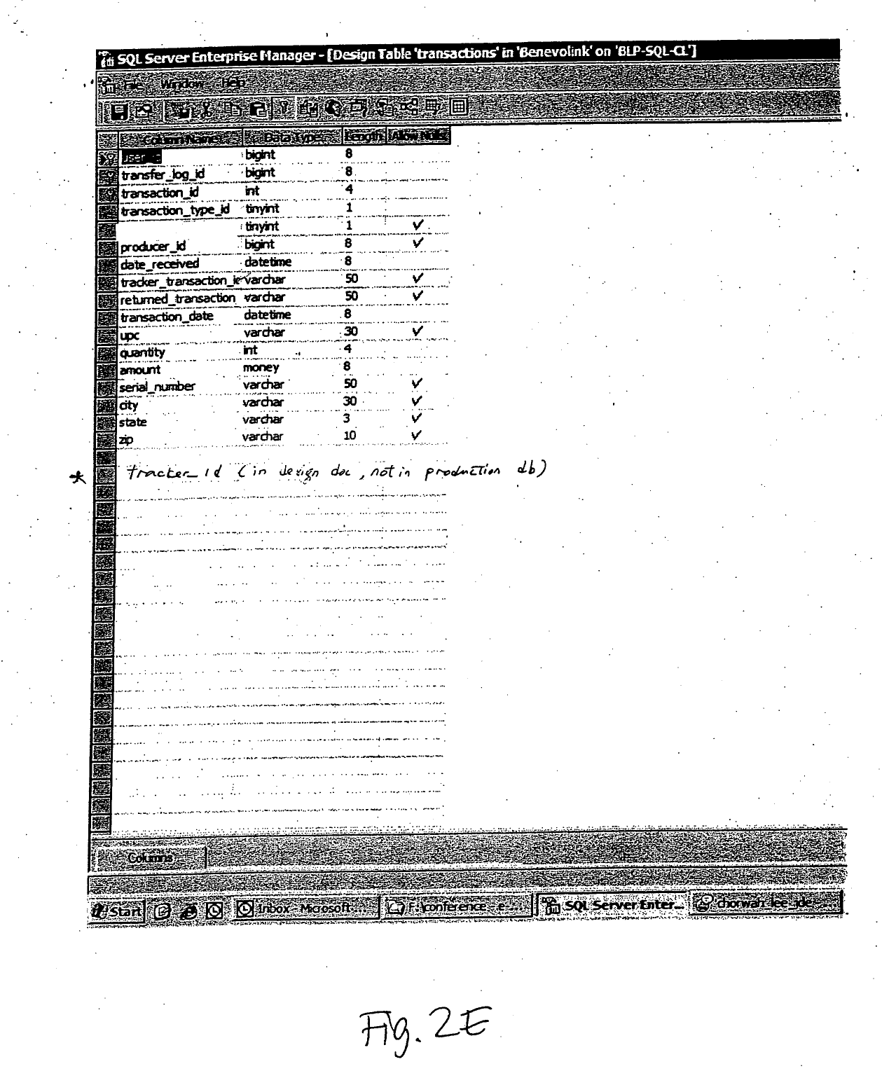

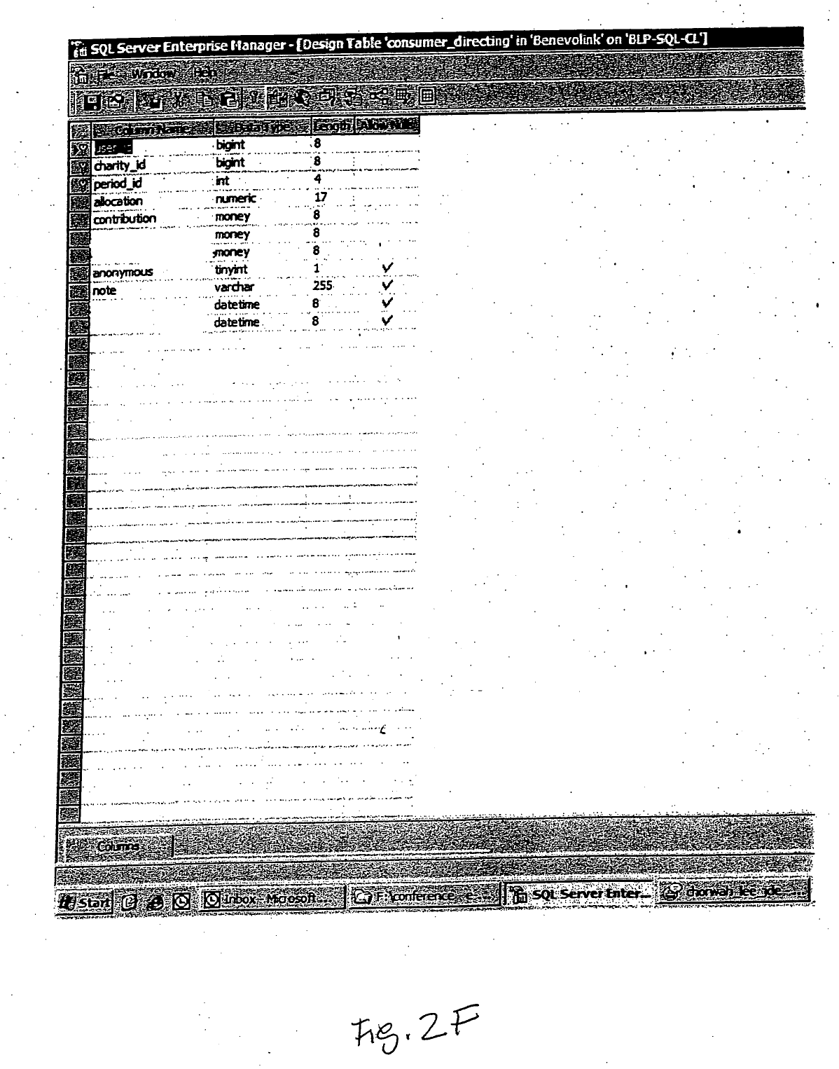

The dynamic nature of the present invention focuses on the consumers' information. Consumers' purchases of specified eligible products enable them to exercise directing power over charitable contributions by program partners. The collected consumer data is organized into three sections, each representing a separate operational function, i.e., registration, purchasing, transactions, and consumer directing. FIGS. 2A-2C illustrate exemplary consumer data elements for each of these operational functions.

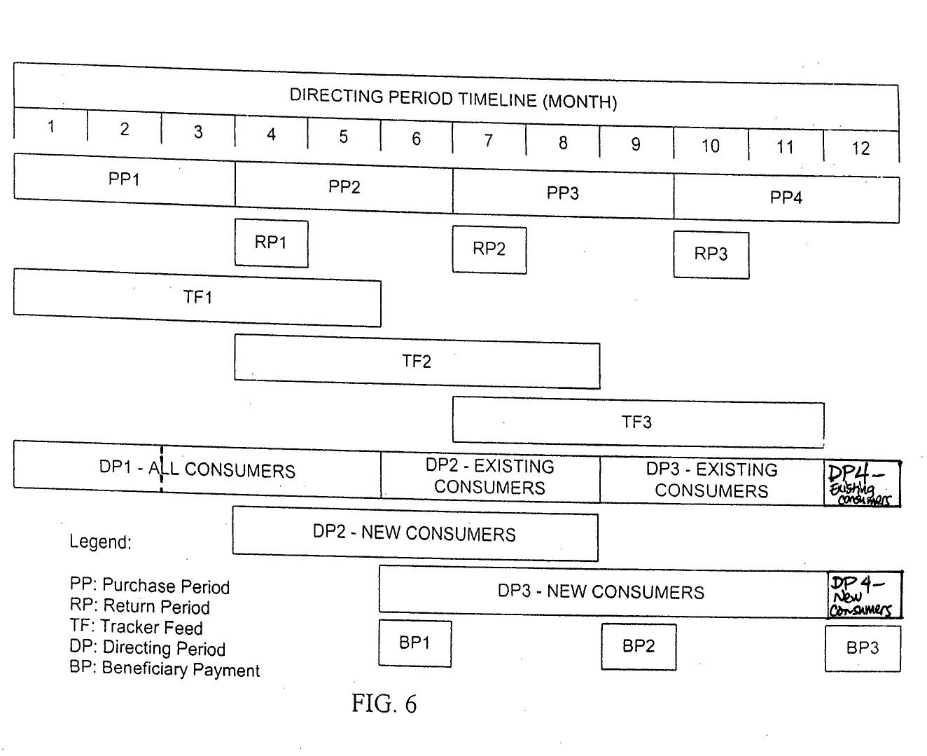

The consumer purchase transaction data elements illustrated in FIG. 2B are collected from trackers to calculate the aggregate directing rights generated by consumer spending by product group and by purchase date. The consumer data directing elements illustrated in FIG. 2C represent data collected from the consumer identifying the beneficiary organizations to which the consumer selects to direct funds for a given purchase period. Data relating to a consumer's own contribution(s) (i.e., funds), as well as data regarding other consumers' account(s) to whom a consumer would like to transfer his or her directing rights may also be collected. This data is collected during a finite directing period that is scheduled as shown in the exemplary timeline of FIG. 6. The consumer directs the allocation of aggregate funds generated during the relevant purchase period, including his or her own funds. The amount the consumer directs can only be an estimate during the directing period because the actual direction can only be calculated at the end of the directing period. The directing value of consumers who fail to direct their share is added to those consumers who do direct, thereby increasing the funds available to directing consumers. However, in some embodiments, the personal contributions of consumers are not added to those of consumers who do direct because direction is required at the time the consumer provides a source of funds (e.g. credit card). Other bonus funds may be available for directing depending upon the program partners' chosen product donation rules. An example of such funds may comprise matching funds that a program partner or other individual or entity, for example, may agree to contribute based on a consumer personal contributions.

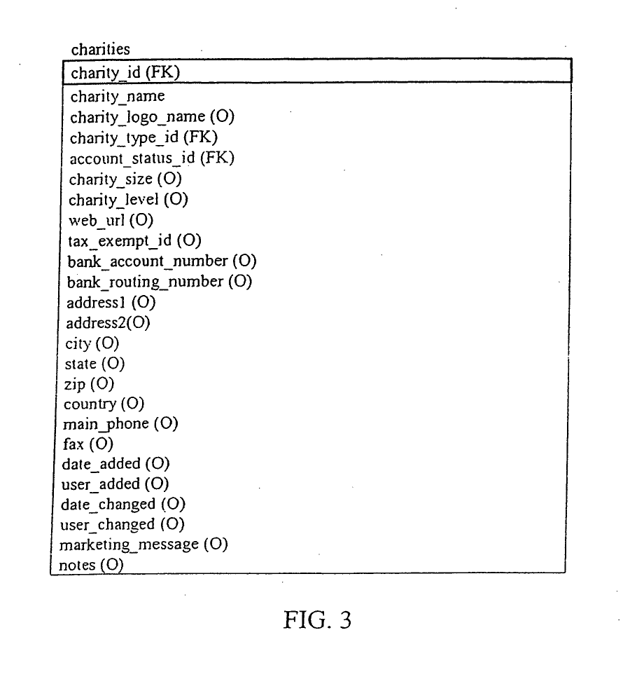

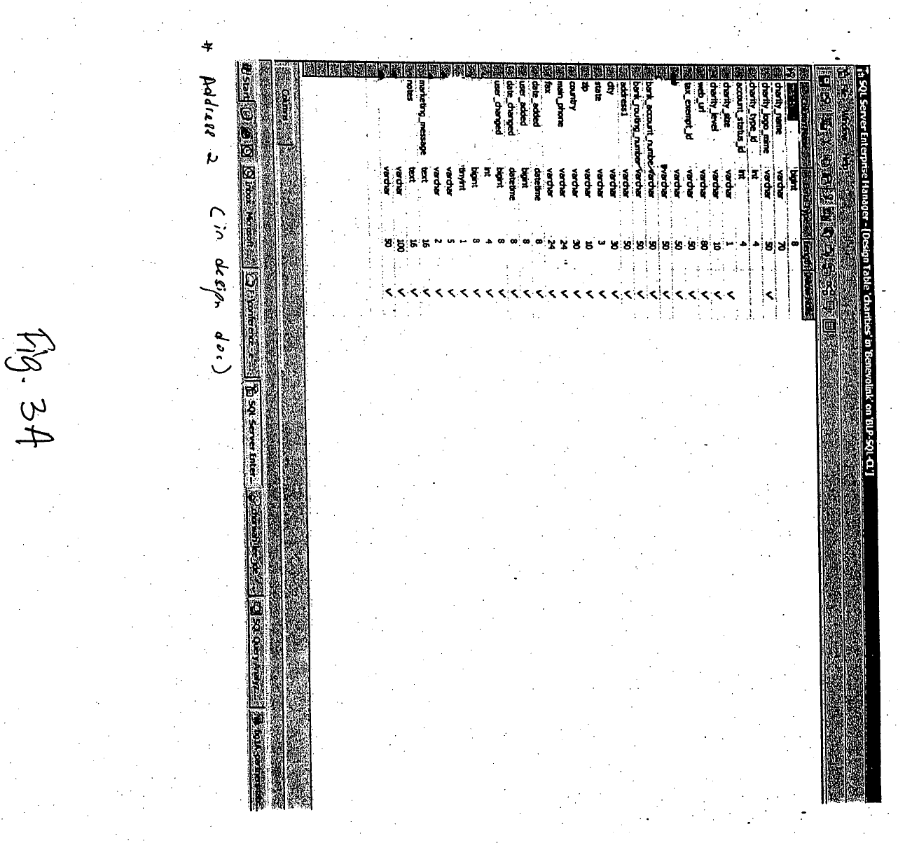

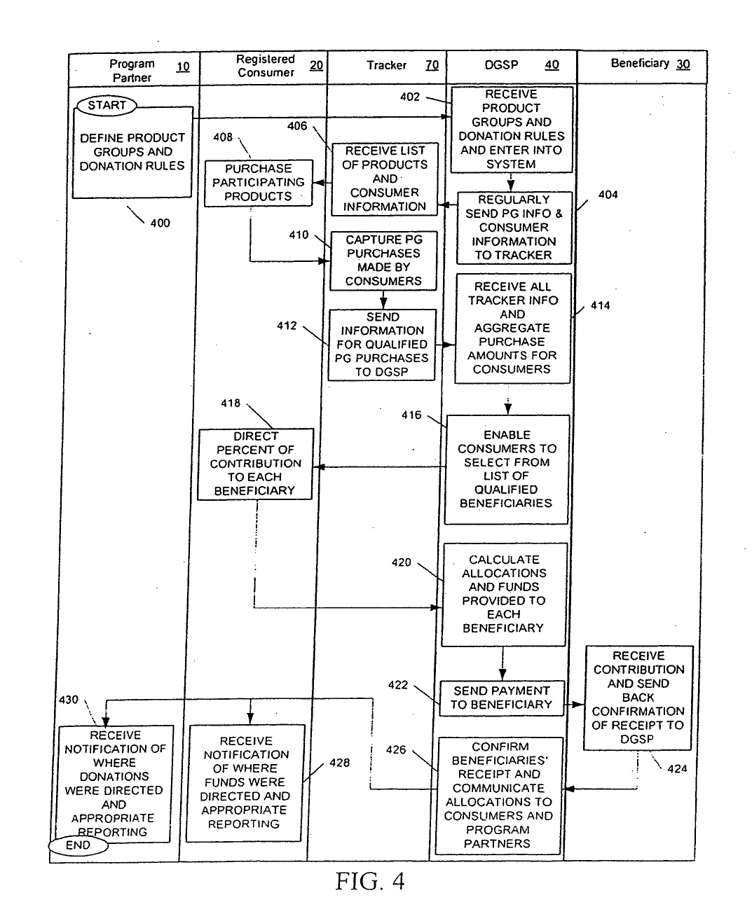

The DGSP maintains a database of beneficiary organizations. Sources for this data may include publicly available data concerning charities, verified consumer nominations or beneficiary self-nominations. FIG. 3 illustrates the elements collected and stored when a beneficiary organization registers with the DGSP. Beneficiary organization registration data may be collected at any time, and the detail collected supplements and qualifies the master database of beneficiary organizations. The DGSP validates and verifies key details of each beneficiary organization before funds can be directed to it. Certain items will be verified off-line via the DGSP's registration process, including the taxpayer identification number, tax exempt status and bank routing and account numbers.

Program partner data is collected based on the DGSP's agreement with the program partner. The DGSP manually enters details into the DGSP system for each product group promotion. There is direct access to the program partner database at the DGSP website.

The primary consumer registration data collection occurs via the DGSP's website. Alternative forms of registration including call centers, facsimile, and/or mail registration may be available.

Consumer purchase data is collected via tracker data feeds. Such a process will occur on a scheduled basis, and may be daily, weekly, monthly, or at some other interval depending upon the agreement between the tracker and the DGSP. Purchase data can be collected regularly with a date/time stamp. Purchase data transfer requires collaboration with the tracker. The DGSP and the tracker define data points that are transferred and set up a time table for the transfer. Transfer can be accomplished with a dedicated File Transfer Protocol (FTP) site that receives encrypted data via Extensible Markup Language (XML). The DGSP system can sweep the FTP sites, verify the quality of the data (i.e., no corruption) and then upload the data into the consumer database at the DGSP website. There can be multiple feeds or sources for each product group. A permanent record of every single tracked consumer product purchase is stored and accessible via search query.

The consumer directing data capture process is a significant function of the system. The primary method of directing data collection occurs via the DGSP website. Directing occurs according to the schedule as laid out in FIG. 6. Consumers can search the DGSP's database for a list of approved beneficiary organizations, and can nominate any new beneficiary organizations that are not already on the list. The consumers can choose to donate all of his funds to a single beneficiary organization or to split his donations across multiple beneficiary organizations of his choosing, allocating percentages of his directing rights to each beneficiary organization. The consumer has the option to have his beneficiary directing percentages pre-filled based on his previous directing history or potentially based on third party recommendations, but must make contact to elect such options. Consumers can also contribute their own funds and direct which beneficiary(ies) receive such funds. Consumers can also designate other consumer(s) and/or consumer account(s) to whom their directing rights are to be transferred to.

Before the DGSP authorizes payments to beneficiary organizations, it must complete collecting purchase data for the relevant purchase period. This could be as short as a four to eight week period in which to receive all tracker data feeds, including those related to allowable returns. The DGSP reviews the purchase data and collects item information for such things as “special item” purchases. For purposes of the present invention, a special item purchase is a product that is eligible for registered consumers to purchase and to be tracked in the DGSP system, but is not captured in the system via an electronic transmittal from the program partner. Consumers are required to either call in or register special item purchase information on-line. The DGSP reviews the special item purchase information for accuracy and authenticity and may verify the information through external sources.

FIG. 6 illustrates a directing period timeline in an exemplary embodiment of the invention. The directing period timeline 700 depicted covers a 12 month period for illustration only. The 12 month period is divided into quarterly purchase periods (PP1-PP4). Once the three month purchase period ends, the DGSP system allows one month for merchandise returns. This is reflected in the RP1-RP3 blocks in the chart. Once the return period is over, the DGSP system allows an additional month to receive all final tracker feeds (TF1-TF3). At the end of the tracker feed period for the corresponding purchase period, the directing period also ends and the beneficiary payment period (BP1-BP3) commences. The initial directing period (DP1) is shown as five months long in FIG. 6. This covers the first purchase period (PP1), the first return period (RP1) and the first tracker feed period (TF1). All registered consumers can direct during this initial cycle, including, for example, contributing and directing their own funds, and directing transfer of their directing rights to other consumers and/or consumer accounts(s). On subsequent cycles in this exemplary embodiment, the directing periods for existing registered consumers occur quarterly. Initial directing periods for new consumers (DP3) commence at the date of registration and end at the end of the corresponding tracker period. DP4 may cover the twelfth month and the following two months, as shown by the dashed line in DP1. New consumers are added to the existing consumer file for subsequent directing periods. In other words, a new consumer will automatically be placed in the directing period that corresponds with the purchase period on the date of registration.

The initial establishment of the beneficiary list is based on a data upload on the DGSP's website of the most well-known beneficiaries. These entities will be deemed “active,” and consumer-directing will be possible. This list grows through updates from third party sources and as registered consumers nominate their schools, places of worship, or other causes for addition to the database. Additional beneficiary organizations are nominated for the list via web-based data capture functionality. Nominated entities will receive a “pending” status until its legitimacy is established by the DGSP. It is not possible for a consumer to direct funds to a “pending” entity. The search functionality and a check-on entry process ensures that a currently “active” beneficiary organization is not added again as a “pending” beneficiary organization. The web-based beneficiary data collection from external sources may be incomplete and must be augmented by the nominated beneficiary organization and verified by the DGSP representative before it is deemed “active”. Once a beneficiary organization is added to the active list, it will remain on the list from directing period to directing period unless removed by a DGSP representative. Periodic checks to ensure that the list is accurate are handled off-line.

A “pending” page on the DGSP's website will present to consumers a list of those entities that have been nominated but have not provided sufficient information to become “active”. The DGSP's web site will include a sign-up sheet for consumers who share an interest in directing to a “pending” entity. When activation of the beneficiary organization occurs, consumers will be notified of their ability to direct to that entity.

Various reports are the primary output of the manipulated data maintained at the DGSP's website. Certain reports are displayed via the website, while others are in a format for sending to external applications. Generic information such as global results (current, historical, cumulative) are available to all participants via the DGSP website. One of the external applications to which data is sent is an automated data processing system (ADP) for beneficiary payment processing.

The DGSP system calculates the program partner specific information to be displayed via the web, email or standard document. The program partner specific information available includes: (1) total program partner revenues generated by registered consumers and tracked by the directed DGSP; (2) total number of registered consumers that purchased its product; (3) total number of products sold to registered consumers; (4) beneficiary organizations that received its charitable contributions (unless suppressed by the program partner); (5) the actual amount of program partner funds directed; (6) historical and cumulative data for each of the previous items; and (7) associated fees paid to the DGSP.

The DGSP system calculates simple consumer specific information that can be viewed from a registered consumer's on-line account and/or via email blast. This information includes automated confirmation emails after registration; automated directed giving website reminder emails for directing; email blasts based on consumer account activity or consumer profile at setup; event specific emails (e.g., earn extra directing dollars when you buy product X during cause Y awareness week); view of total consumer spending to date for the purchase period; view of consumer estimated directing funds before and during the directing period; view of consumer actual directing history by directing period and on a cumulative basis; and targeted banner ads.

The DGSP system determines the amount due to each beneficiary organization and makes payment of these funds by either making payments directly to each beneficiary or sending beneficiary payment processing information to external sources such as ADP. The DGSP system calculates the beneficiary organization specific information to be displayed via the DGSP website, email or standard document. Some of this information is pre-defined, while other information will be the result of one-off queries. The information provided to beneficiary organizations includes total contributions, the names and amounts contributed by specific consumers (unless the consumer chooses anonymity), and the names and amounts contributed by specific program partners (unless program partners choose anonymity).

The DGSP can mine the data collected to determine totals and trends across the system, plus perform ad hoc data manipulation.

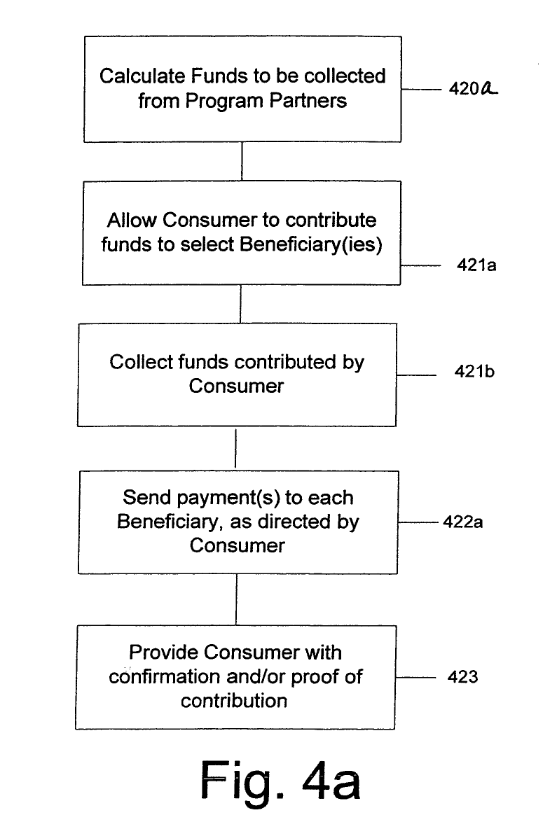

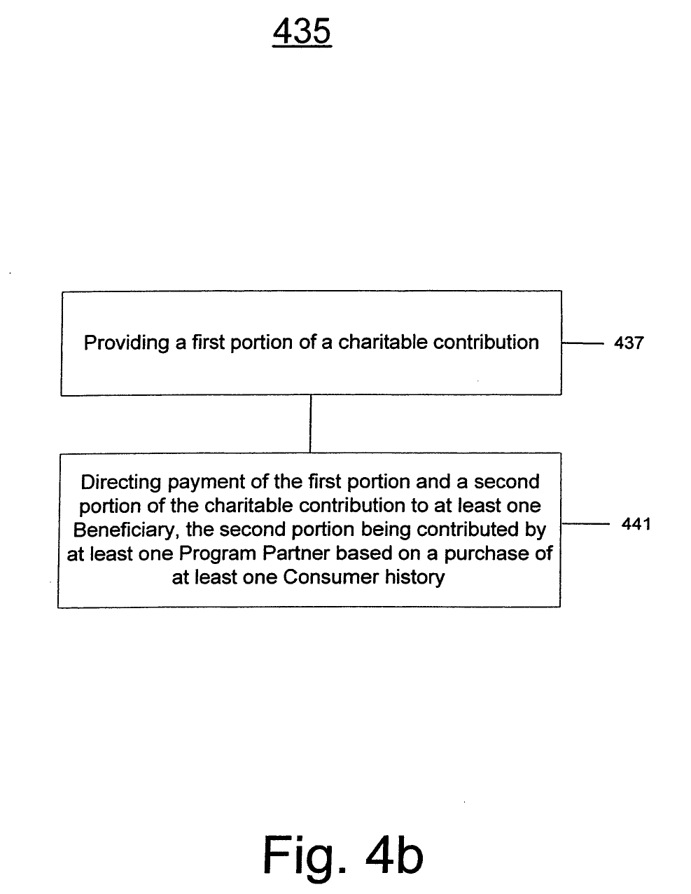

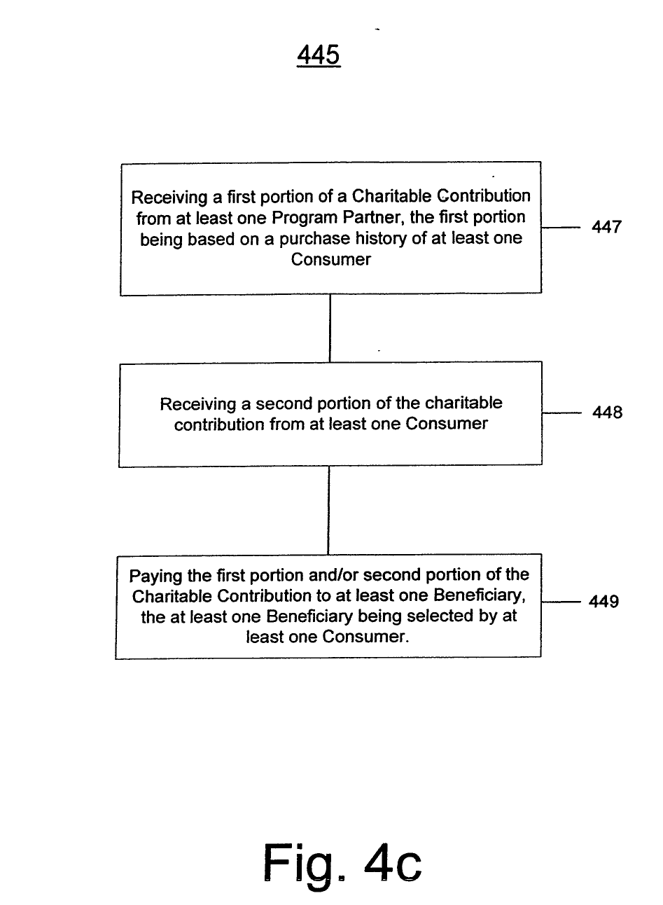

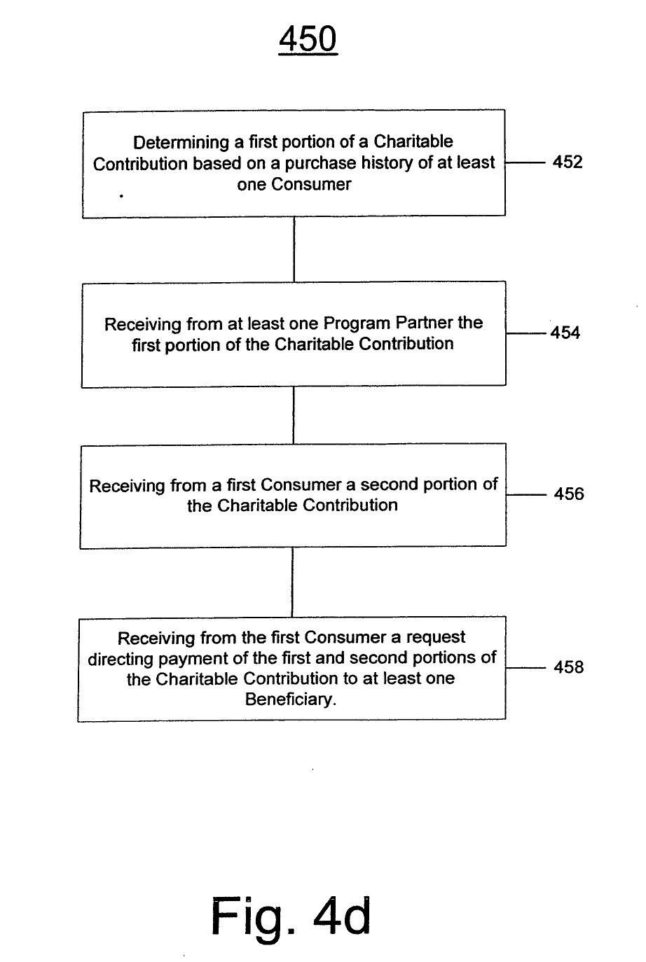

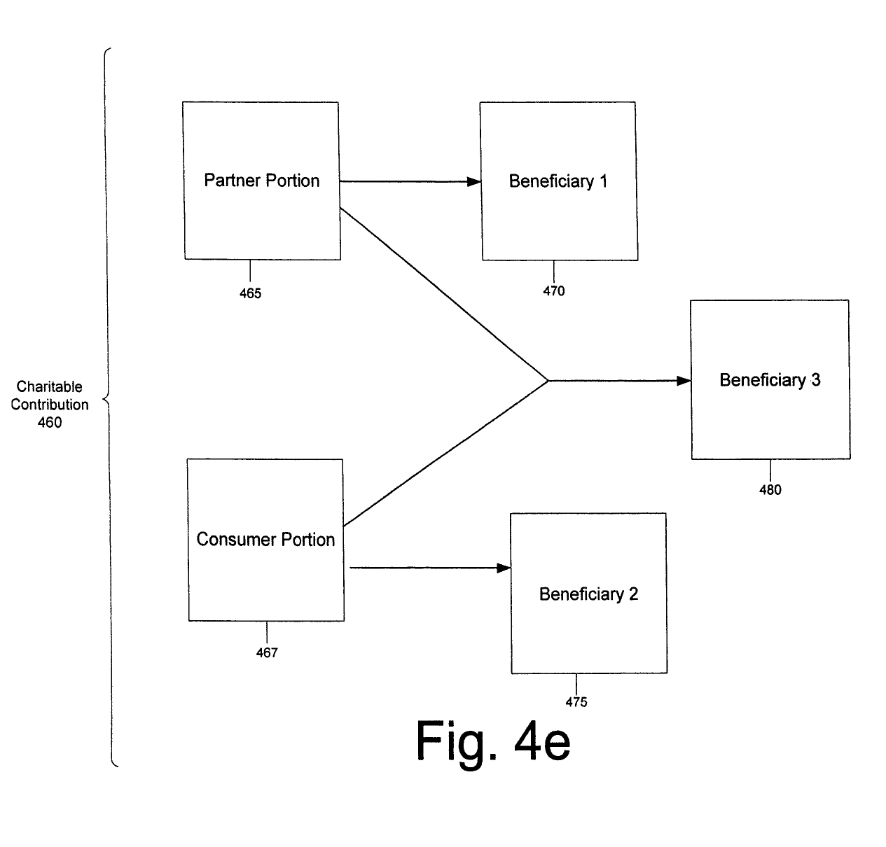

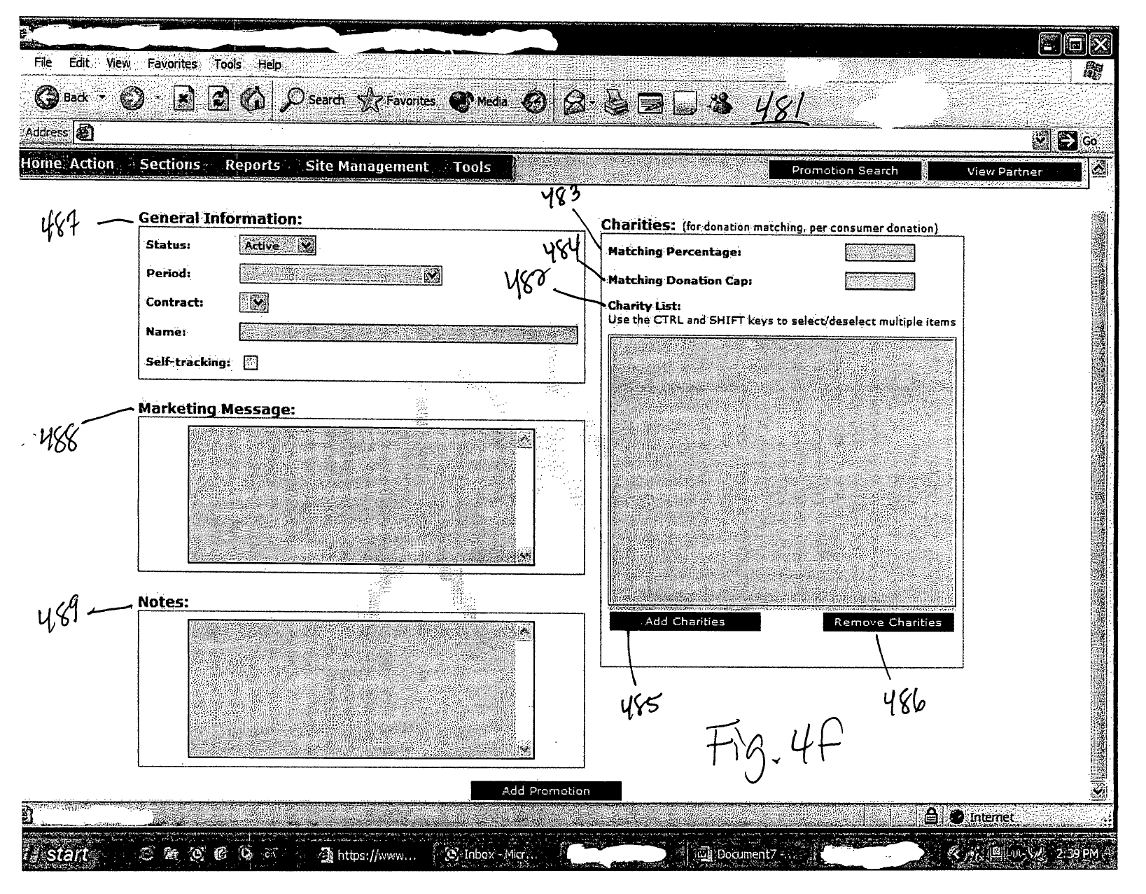

The process flow diagram for enabling consumers to direct corporate charitable contributions through aggregated purchase decisions is illustrated in FIG. 4. The different parties involved in the process flow include the program partner 10, the registered consumer 20, the beneficiary organization 30, the DGSP 40, and the tracker 70.

A number of key assumptions are associated with the process flow depicted in FIG. 4. These Include: (1) the tracker has entered into a contract with the DGSP; (2) the program partner has entered into a contract with the DGSP; (3) a beneficiary organization list exists; (4) the consumer has registered with the DGSP and provided information regarding trackable methods of purchase: (5) the tracker has a tracking mechanism and has tested its data transfer process with the DGSP: (6) product groups are defined and product donation rules exist and the relevant parts are communicated to the tracker and the consumer; and (7) consumer purchases accounts (CPAs) exist and are communicated to consumers.

The process begins in logic block 400 with the program partner selecting its product groups and product donation rules and the DGSP receiving that information and entering it into the DGSP system (logic block 402). The DGSP regularly sends the relevant product group information and directed giving system member IDs to the tracker or its information services provider, as indicated in logic block 404. The tracker or its information services provider 70 receives a list of products and the member IDs as indicated in logic block 406. The registered consumer 20 purchases participating products as indicated in logic block 408. The tracker or its information services provider 70 captures the product group purchase information generated by consumer purchases of participating products, as indicated in logic block 410. The tracker or its information services provider 70 sends information for qualified product group purchases to the DGSP 40 as indicated in logic block 412. Next, in logic block 414, the DGSP 40 receives all tracker information, calculates and aggregates the directed giving rights generated by each consumer purchase. The consumers are then provided with a list of qualified beneficiary organizations in logic block 416. This is followed by the registered consumer 20 directing a percentage of contributions that he controls to each beneficiary organization selected as indicated in logic block 418. The DGSP 40 then calculates allocations and funds to be provided to each beneficiary organization as indicated in logic block 420. The DGSP 40 sends required payments to each beneficiary organization in logic block 422. The beneficiary organization 30 receives the contribution. Next, as indicated in logic block 426, the DGSP 40 confirms the beneficiary's receipt and communicates allocations to both consumers 20 and program partners 10. Registered consumers receive notification of where their consumer purchase accounts were directed as indicated in logic block 428. The program partner 10 may elect to receive notification of where its contributions were directed as indicated in logic block 430. Logic blocks 428 and 430 are the last steps in the overall process flow.

FIG. 4a illustrates an exemplary processing logic for enabling consumers to contribute their own funds in addition to or as part of directing charitable contributions through aggregated purchase decisions. In some embodiments, contributions given through credit cards require a minimum contribution. In some embodiments, the process of contributing consumer funds may be incorporated as part of the process flow disclosed in FIG. 4. That is, consumer contributions may be made along with charitable contributions collected from program partners. According to various embodiments of the invention, consumers may opt to contribute their own funds to select beneficiaries or charities, which may or may not receive contributions collected from program partner(s). In some embodiments, consumer contributions may be sent along with contributions collected from program partners, while in other embodiments, consumer contributions may be sent regardless of whether charitable contributions are being collected from program partners.

In FIG. 4a, at step 420a, for example, charitable contribution funds to be collected from program partners are calculated, such as on an aggregate and/or individual consumer basis. According to some embodiments, calculation of such funds may be based upon tracked purchases of registered consumers using a variety of possible calculation methods. These may include, but are not limited to, a stated percentage of consumer purchases, a flat fee per unit purchased, or a fixed amount to be shared equally across all purchases for a defined time period, either by purchase value or by unit.

At step 421a, a consumer may be allowed to contribute his or her own funds to select beneficiaries or charities. In some embodiments, consumers may be presented with the allocations and funds calculated in step 420a. This way a consumer may decide whether he or she wishes to increase the charitable contribution and may do so by specifying a particular dollar amount he or she would like to contribute, as well as designate a funding source, such as his or her checking account or credit card, for example. For instance, assume the calculation in step 420a indicates that a particular charity—Charity A—is to receive a charitable contribution of $23.54. A consumer may decide that charity A should receive more money, and may contribute his or her own funds to increase the amount of the contribution, such as by rounding the charitable contribution to a predetermined whole dollar amount, $35.00, for example. In some embodiments, the consumer can allocate a predetermined minimum amount, e.g., ten dollars ($10.00), among up to one thousand (1000) beneficiaries, i.e., one (1) cent per beneficiary. According to some embodiments, consumers may designate the same or different beneficiaries for contributions collected from program partner(s) and those provided by the consumer. In some embodiments, delivery of consumer contributions may be restricted to certain predetermined periods, such as the directing periods described above and in FIG. 6, for example.

At step 421b, in FIG. 4a, the consumer contribution may be collected, for example, by the DGSP. According to one embodiment, collection may comprise deducting the contributed amount from an account associated with the consumer, such as a credit or debit card, a checking or savings account, for example, or other common or acceptable form of payment. In other embodiments, collection may comprise receiving the consumer contribution via wire transfer, e-money, or via any third party service or provider that coordinates online payment transfers, such as known PayPal™, for example, or other similar known processes.

Next, at step 422a the total payment to the select beneficiaries or charities may be sent. In some embodiments, the total payment comprises funds collected from various program partners as described herein, funds contributed exclusively by consumer(s), or some combination of both. At step 423, the consumer may be provided with a confirmation of payment and/or proof of his or her contribution. In some embodiments, such confirmation and/or proof may comprise a receipt indicating the amount of the consumer's contribution. Similarly, receipts may be provided to a program partner when funds are collected therefrom. In some embodiments, the receipt may come from the DGSP, while in other embodiments the receipt may come from the charitable organization or other party that administers contributions. In various embodiments, such receipt may be provided electronically (such as via email or the Internet, for example) or via standard mail delivery services.

FIG. 4b illustrates an exemplary processing logic 435 for enabling consumers to contribute their own funds. At step 437, the consumer, for example, may provide a consumer portion of the charitable contribution. In some embodiments, a DGSP, for example, may collect from at least one Program Partner a partner portion of the charitable contribution, either before, after or during the time the consumer provides his or her consumer portion. According to various embodiments, the partner portion of the charitable contribution may be based on one or numerous consumer(s) purchasing patterns, for example. In some embodiments, the consumer portion may comprise a particular amount that the consumer would like to donate over and above the partner portion being collected from the at least one Program Partner, for example. Thus, if the program partners are donating $27.00, the consumer may wish to add $3.00 dollars from his or her own funds to increase the total contribution to $30.00. At step 441, the consumer or DGSP, for example, may direct, donate, transfer and/or pay the consumer and/or partner portions of the charitable contribution to at least one beneficiary. According to various embodiments, the at least one beneficiary is selected by the consumer, and may or may not be the same beneficiary receiving funds collected from the Program Partner(s).

FIG. 4c illustrates an exemplary processing logic 445 for enabling consumers to contribute their own funds. At step 447, a partner portion of a charitable contribution may be received or collected by the DGSP, for example, from at least one program partner. According to some embodiments, the partner portion is based on a purchase history of at least one consumer. In some embodiments, the partner portion is collected in response to a request from at least one consumer and/or the DGSP to provide the funds. In various embodiments, the partner portion is provided to the DGSP. Next, at step 448 the DGSP, for example, may receive a second portion of the charitable contribution from at least one consumer. In some embodiments, the second portion of the charitable contribution may comprise an online consumer contribution donated by at least one consumer. At step 449, the DGSP, for example, may pay the first and second portions of the charitable contribution to at least one beneficiary.

FIG. 4d illustrates an exemplary processing logic 450 for enabling consumers to contribute their own funds. At step 452, a DGSP, for example, may determine a first portion of a charitable contribution. In some embodiments, the first portion may be based on a purchase history of at least one consumer, such as particular consumer purchases from particular Program Partner(s), for example. According to various embodiments, the DGSP may request that the determined first portion, for example, be provided by at least one Program Partner. At step 454, the DGSP, for example, may receive or collect from at least one Program Partner the determined first portion of the charitable contribution. Next, at step 456 the DGSP, for example, may receive a second portion of the charitable contribution. In some embodiments, the second portion may be provided by or received from at least one consumer. At step 458, the consumer, for example, may request that the DGSP to direct payment of the first and/or second portions of the charitable contribution to at least one beneficiary. In other words, the consumer may designate particular beneficiary(ies) to receive some or all of the charitable contributions.

According to various other embodiments, consumers may be allowed to contribute their own funds online at any time. In some embodiments, allocation of such funds may be coordinated on a predetermined timeline, such as that described in FIG. 6. Consumers may also search for particular charities or beneficiaries to donate to, which may or may not be the same charities or beneficiaries receiving donations from Program Partners, for example. In some embodiments, consumer contributions may be distinguished from Program Partner contributions to enable easy tracking. Transaction fees may also be charged for consumer contributions, such as by a DGSP, for example.

FIG. 4e illustrates a block diagram summarizing the general flow of charitable contributions described herein. According to some embodiments, charitable contribution 460 may comprise two portions: a partner portion 465 and a consumer portion 470. In some embodiments, partner portion 465 may be collected by a DGSP, for example, from at least one Program Partner and may be based on the purchase history of one or various consumers, for example. Consumer portion 470 may be collected by a DGSP, for example, directly from at least one consumer(s).

According to various embodiments, one or various consumers may direct how payment of charitable contribution 460 is to be made, such as by a DGSP, for example. For instance, as shown in FIG. 4e a consumer may designate that Beneficiary 1 (470) receive the aggregated partner portion 465, and that Beneficiary 2 (475) receives the consumer portion (467). Alternatively, the consumer may designate that Beneficiary 3 (480) receive all of charitable contribution 460. In some embodiments, the consumer may only designate the aggregated amount. Other distribution arrangements are of course possible.

According to various embodiments of the invention, a program partner may match or contribute funds based on: (1) consumer earned designation rights; or (2) consumer contributions. In the former, the program partner may match or contribute funds based on a consumer's purchases, for example. In the latter, the program partner may merely match a consumer's contributions. In some embodiments, therefore, matching by program partners may encourage consumers to contribute funds in a general way (e.g., based on consumer contributions), or in a more targeted or specific way (e.g., based on consumer's specific purchases or contributions).

A program partner's matching contributions, for example, may be limited or defined by three components: (1) a percentage component, (2) a condition component, and/or (3) a numeric (or cap) component. A percentage component may limit a program partner's contribution to a predetermined percentage of the consumer's contribution(s), for example. A condition component may specifically limit a program partner's contribution based on a predetermined event or occurrence. For example, a program partner may contribute funds only if the consumer purchases a particular product or service (e.g. its own products or services), or only if the consumer contributes funds to a select group or organization (e.g. American Heart Association). A numeric component (or cap) may limit a program partner's contribution(s) to a particular or predetermined amount.

FIG. 4f illustrates one embodiment of an interface 481 that an administrator of a DGSP, for example, may use to provide parameters relating to the matching feature of the claimed systems and methods. Charity list 482 may designate a list of charities that a particular program partner, for example, may make contributions to based on consumer contributions or activity. For example, a particular program partner department store may commit to make matching contributions to a particular charity based on a consumer's purchases of specific product(s) or service(s). Similarly, the program partner department store may be willing to match a consumer's contribution so long as the consumer is contributing to a particular charity. Either way, the list of charities in list 482 may comprise the various charities to which the program partner department store is willing to make matching contributions. Add charities box 485 and remove charities box 486 may be initiated to add or remove charities as necessary.

In some embodiments, a program partner's matching contributions may be limited as set forth in matching percentage box 483 or matching donation cap box 484. For example, the program partner department store may agree to match each $25 contributed by a consumer with a $10 contribution of its own, or one equaled to 35% of the consumer's contribution. In some embodiments, program partner matching contributions may be capped at a predetermined amount. For example, the program partner department store may be willing to make matching contributions of $10, but only up to a total of $1 million. Matching limitations (e.g., cap, percentage, flat amount) may be co-related with specific charities (and consumers) as necessary.

General information box 487 includes information that an administrator of DGSP may wish to provide in connection with the matching feature. For example, the administrator may provide the particular status of a program partner's matching program, the period the program is in effect, whether the program partner is under contract, the name of the program, and whether self-tracking is initiated. In some embodiments, self-tracking icon may designate those program partners, for example, that are able to independently track consumer sales. Marketing Message Box 488 and Notes 489 are available so that an administrator of DGSP may provide information relating to marketing of the matching program and/or general notes about the program.

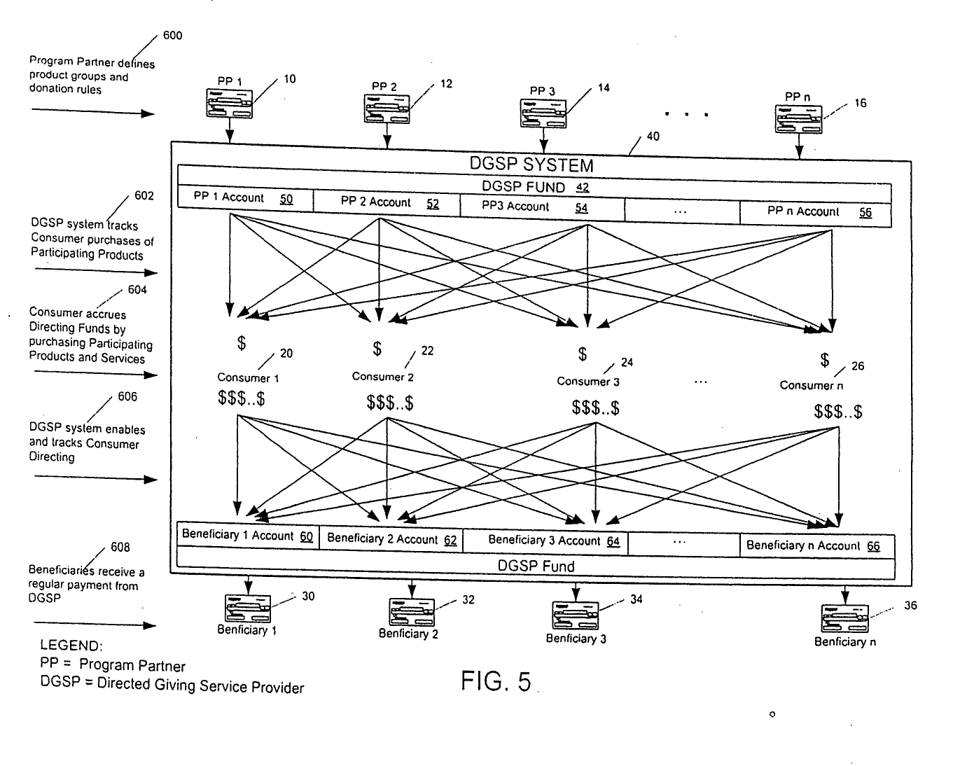

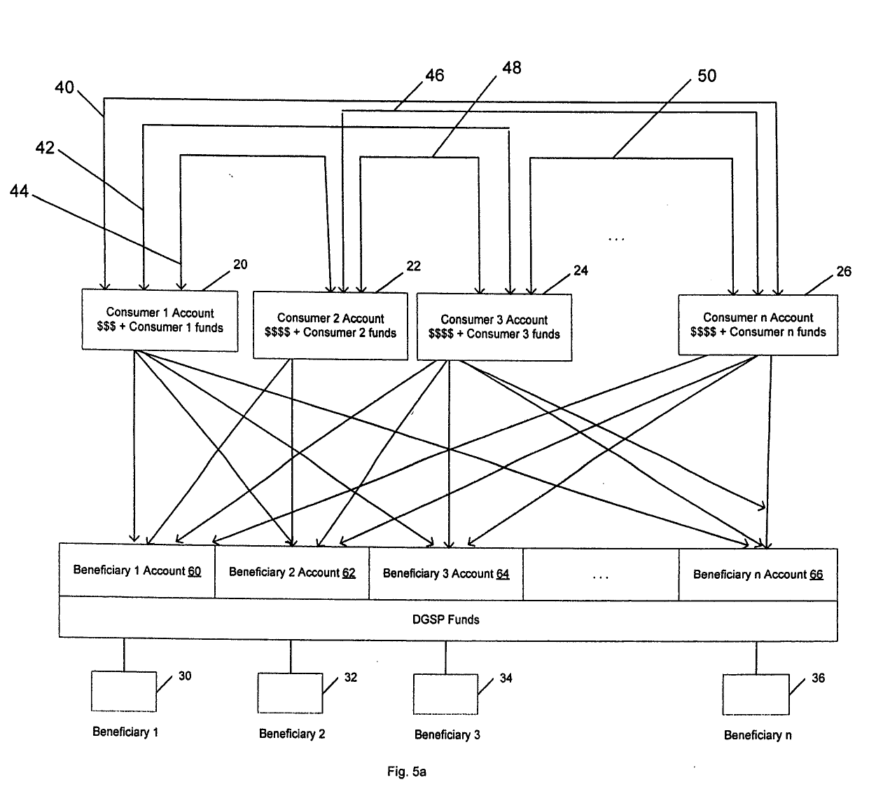

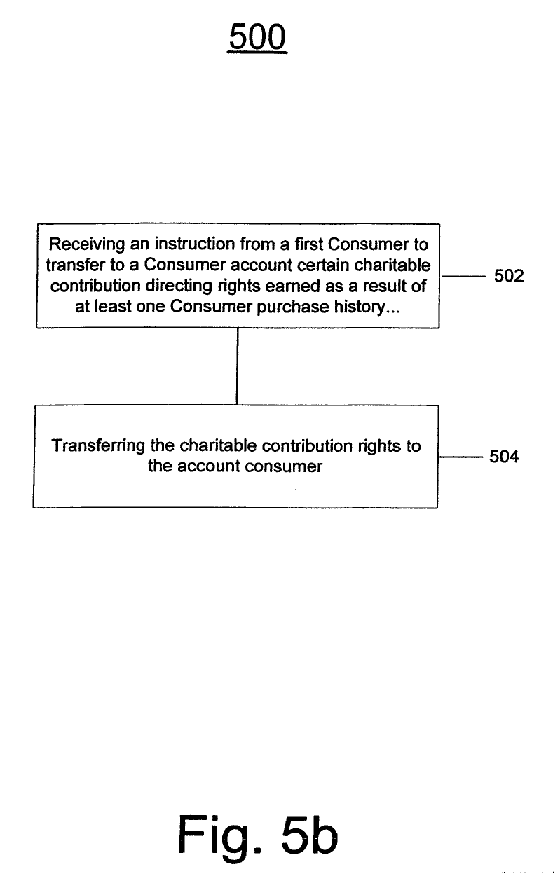

The charitable giving process flow through the DGSP is illustrated in FIG. 5. The figure depicts multiple program partners 10, 12, 14, 16, multiple consumers 20, 22, 24, 26, and multiple beneficiary organizations 30. 32. 34, 36. In this example, the program partners 10, 12, 14, 16 communicate directly with the directed giving system 40. In some cases, such as in the process flow of FIG. 4, information about consumer product purchases would be provided by a tracker or its information systems intermediary. Beneficiary organizations 30, 32, 34, 36 also communicate directly with the directed giving system 40. For each program partner, the directed giving system 40 sets up as part of directed giving fund 42 program partner accounts 50, 52, 54, 56. For each beneficiary organization, the directed giving system 40 sets up individual beneficiary accounts 60, 62, 64, 66. Consumers 20, 22, 24, 26 are seen as collecting and controlling funds from the various program partner accounts. The consumers 20, 22, 24, 26 direct the aggregated amounts to the individual beneficiary accounts 60, 62, 64, 66. The various steps in the overall process of directed charitable giving are shown by the steps above the arrows pointing to the program partners, beneficiary organizations and directed giving system as shown on the left side of the figure. Each program partner defines participating products as indicated by step 600 and regularly makes a single charitable contribution per directing period. The directed giving system tracks the consumer purchases of participating goods and services in step 602. The consumer accrues directing funds by purchasing participating products, as indicated in step 604. The directed giving system enables and tracks consumer directing as indicated in step 606. Finally, the beneficiaries receive a single payment per directing period from the charitable foundation as instructed by the directed giving system as indicated by step 608.

FIG. 5a illustrates a portion of FIG. 5 further describing the consumer's ability to contribute his or her own funds, as well as the ability to transfer contribution rights to other consumer account(s), for example. As shown, consumers 20, 22, 24, and 26 each may be associated with first and second portions of a charitable contribution. The first and second portions are respectively shown in FIG. 5a as “$$$$” and “consumer n funds.” In some embodiments, the first portion may comprise the contribution payable or donated by the program partner(s), while the second portion may comprise the consumer's own contribution, such as is described above and in FIGS. 4, 4a, 4b, 4c, and 4d. According to various embodiments, consumer contributions may be allocated and donated, for example, according to the time line described in FIG. 6. In other embodiments, consumer contributions may be made at any time. As discussed above in connection with FIG. 5, consumers 20, 22, 24, and 26, may then direct the first and second contribution portions as they see fit among the various beneficiaries 30, 32, 34, and 36, for example.

In another embodiment, consumers 20, 22, 24, and 26 may also allocate amongst themselves various contribution direction rights. That is, consumer 20 may transfer some or all of his direction rights from his account to the account of consumer 2, as shown by 44, for example. In various embodiments, contribution direction rights may comprise a consumer's earned right to direct where a particular contribution goes, i.e., who will be the beneficiary(ies) of the contribution. Thus, if consumer 20, for example, has accumulated (through his purchase history, for example), $25,000.00 in contributions, he may transfer the right to designate beneficiaries of such contributions to the accounts of consumer 22, 24, and/or 26, as shown by 44, 42, and 40, respectively. Once transferred consumer 20 gives up all of his directing rights associated with the $25,000, the receiving consumer may then direct the funds, or may instead transfer the direction rights to other consumer account(s), for example. In some embodiments, transferring right to designate does not mean that tax deduction rights are also transferred.

According to various other embodiments, transferring consumers—i.e. consumers that transfer their directing rights to other consumer accounts, for example—may receive confirmation and/or proof that the transfer was completed. In some embodiments, the receiving consumer may designate beneficiaries, or may further transfer the rights to other consumer(s).

FIG. 5b illustrates one embodiment of a method 500 for contributing or donating charitable contributions. According to various embodiments of the invention, a consumer, for example, may transfer his or her contribution directing rights, such as to other consumer(s), and/or consumer account(s) for example. At step 502, for example, a DGSP may receive an instruction from a first consumer, for example, to transfer certain charitable contribution directing rights to a second consumer account, for example. Such directing rights may comprise, for example, directing rights to designate which beneficiary(ies), for example, should receive an allocated contribution amount based, for example, on the first consumer's purchase history. At step 504, the DGSP, for example, may transfer the certain charitable contribution directing rights to the second consumer. In some embodiments, directing rights may be transferred to a plurality of consumer account(s), each with a specific directing right, dollar amount, or limitation (e.g. can donate only to select beneficiaries), for example. In various embodiments, the first consumer may be provided confirmation that the transfer was completed.

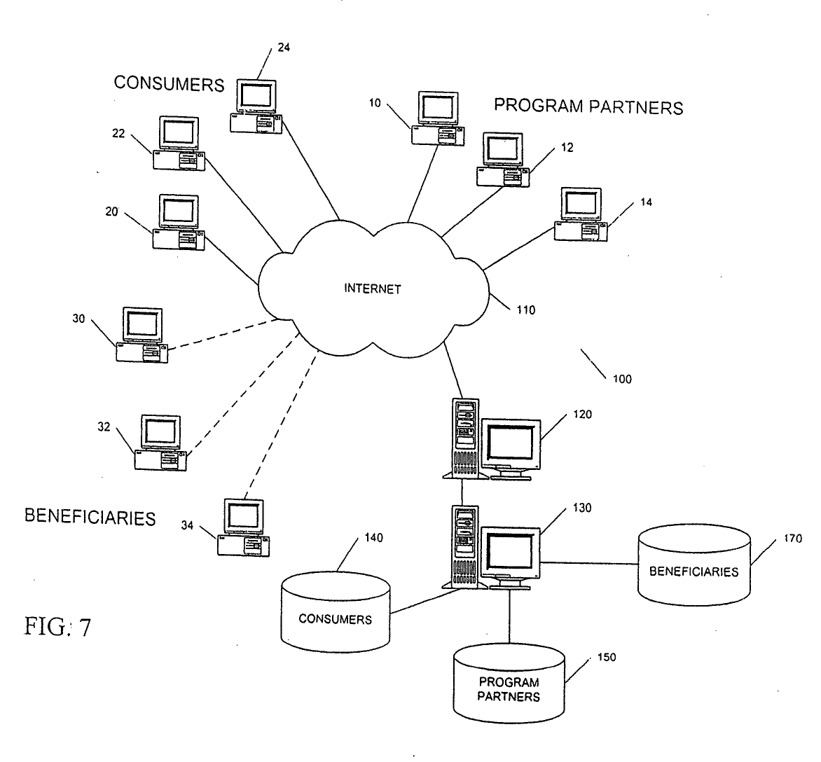

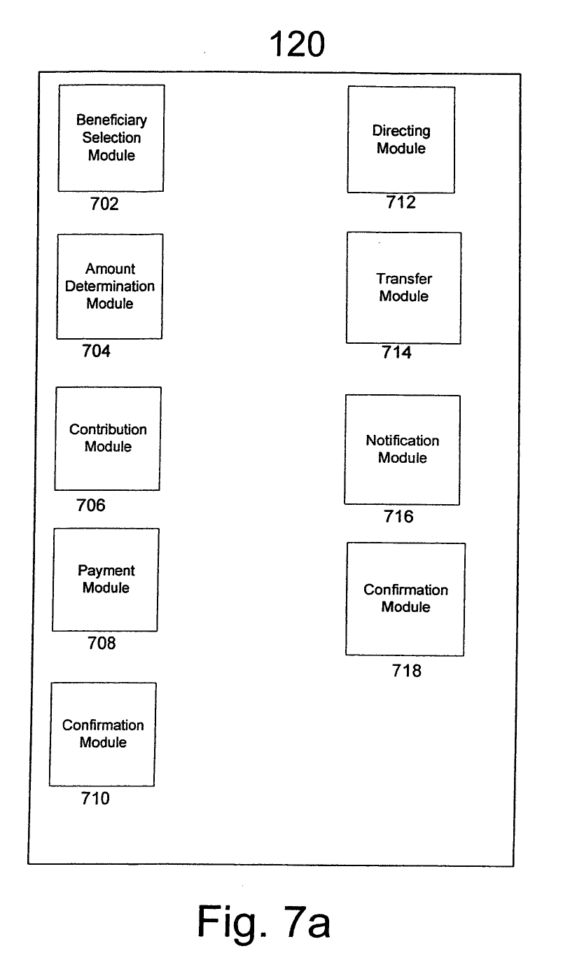

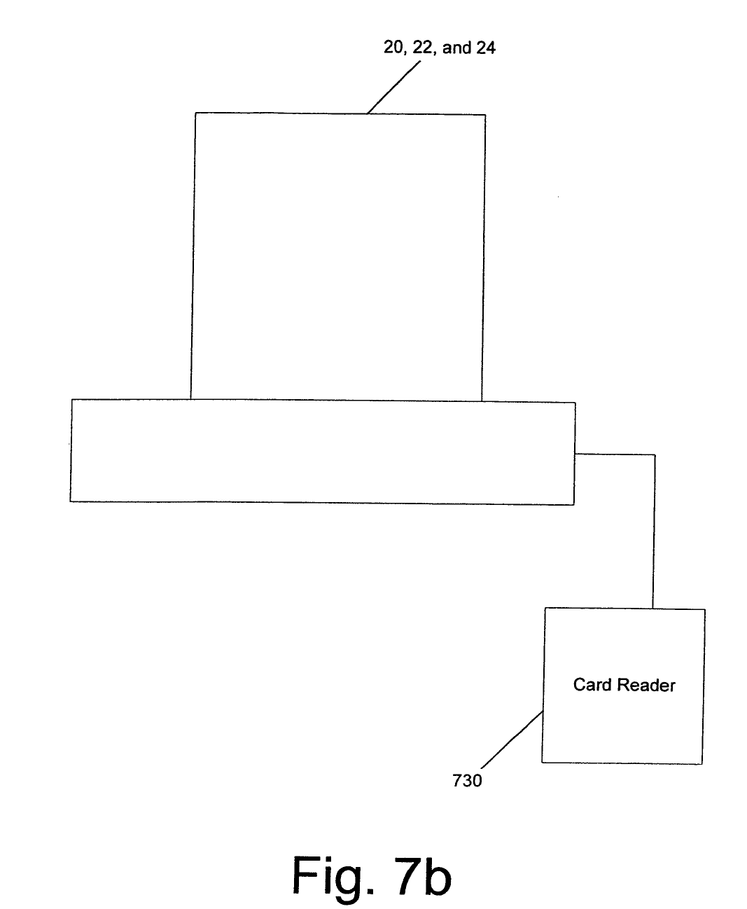

FIG. 7 illustrates a simplified implementation of the directed giving system of the invention. The directed giving system 100 preferably uses a wide area network communications system, such as the global Internet. The directed giving system in the exemplary embodiment is server-based, with at least one server computer 120 and a central database 130 with multiple data files or separate databases 140, 150, 170 corresponding to consumers 20, 22, 24, program partners 10, 12, 14, and beneficiaries 30, 32, 34. The beneficiaries are depicted as having a dashed line connection to the Internet. Although they are the recipients of the charitable giving directed by consumers, they do not play an active role in the directed giving system. In other words, beneficiaries have no control or input to either program partner giving amounts or to consumers' direction of the aggregate amounts.

FIG. 7a illustrates various modules that may be associated with server computer 120, for example, for activating the various features and functionality described herein. In some embodiments, some or all of the modules may be associated with other elements of FIG. 7, such as consumer 20, 22, and 24, program partners 10, 12, and 14, and/or beneficiaries 30, 32, and 34. In some embodiments, the modules may be accessed by some or all of the users or participants that are using system 100, such as consumers, a DGSP, and/or beneficiaries, for example. While the modules may not be necessary to perform some or all of the functions described herein, they are nonetheless presented as possible embodiments:

Beneficiary selection module 702 may be accessed by a consumer, for example, to select at least one beneficiary to receive a charitable contribution. In some embodiments, the charitable contribution comprise funds collected by a DGSP, for example, from one or more Program Partners, and/or funds donated by the consumer.

Amount determination module 704 may be used, for example, to determine at least one charitable contribution amount to be directed to at least one beneficiary. In some embodiments, the at least one charitable contribution amount may be based on consumer product purchase information relating to at least one consumer.

Contribution module 706 may be used, for example, to allow at least one consumer to contribute at least one consumer contribution amount to be directed to at least one beneficiary. Contribution module 706 may operate in conjunction with card reader 730 shown in FIG. 7b or may receive information electronically. Card reader 730 may comprise a kiosk, check-out register, or any other device that is able to read cards.

Payment module 708 may be used, for example, to direct, pay and/or donate a charitable contribution amount and/or the at least one consumer contribution to at least one beneficiary. Confirmation module 710 may be used, for example, to confirm payment and/or donation of at least one consumer amount to at least one beneficiary. Directing module 712 may be used, for example, to send or receive an instruction to transfer to a designated consumer account, for example, certain charitable contribution directing rights earned as a result of at least one consumer's purchase history. In some embodiments, the charitable contribution directing rights comprise rights to direct payment and/or donation of at least one charitable contribution contributed by at least one program partner and/or consumer, for example. Transfer module 714 may be used, for example, to transfer charitable contribution directing rights to a designated consumer account, for example. Notification module 716 may be used, for example, to notify the holder of a consumer account that charitable contribution rights have been received. Confirmation modules 718 may be used, for example, to confirm transfer of charitable contribution directing rights to a designated consumer account, for example. Other modules are possible.

FIG. 7b illustrates one embodiment of a consumer 20, 22, and 24 having a card reader 730 which may be used by a consumer in conjunction with contribution module 706, for example, to contribute funds to a particular beneficiary(ies). In some embodiments, card reader 730 may be used to obtain consumer account information, such as by requesting insertion of a consumer's credit or debit card, for example.

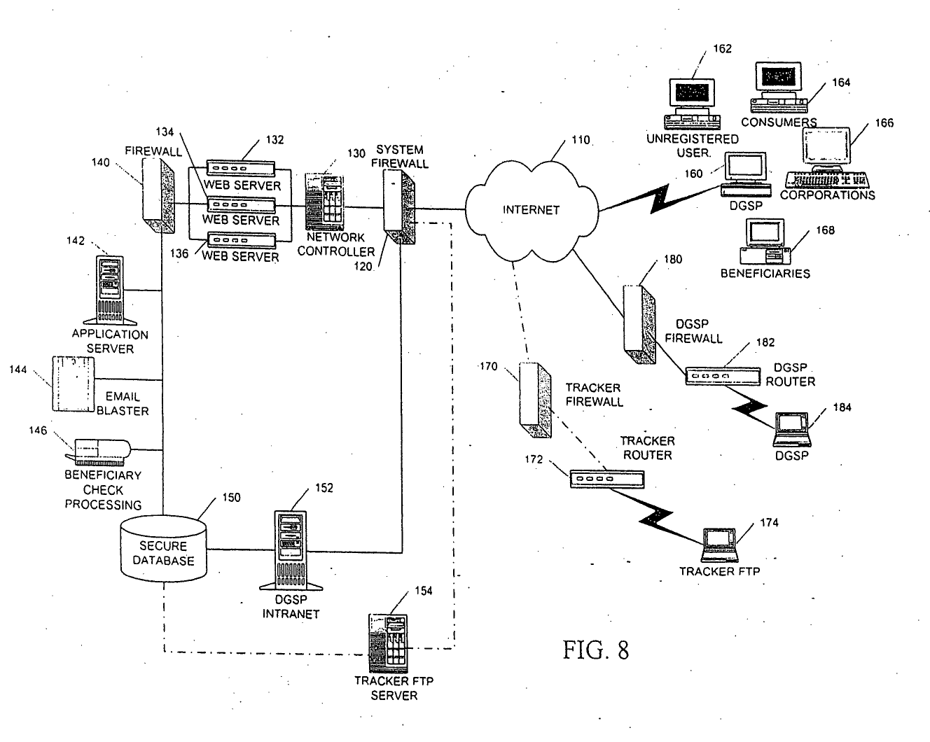

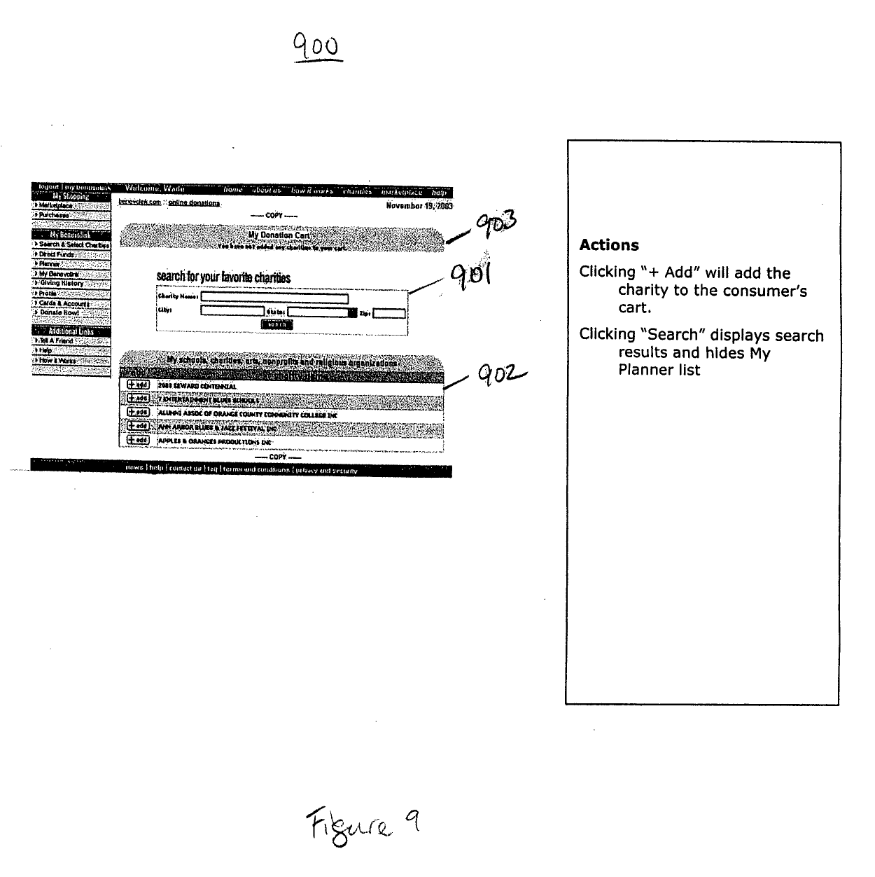

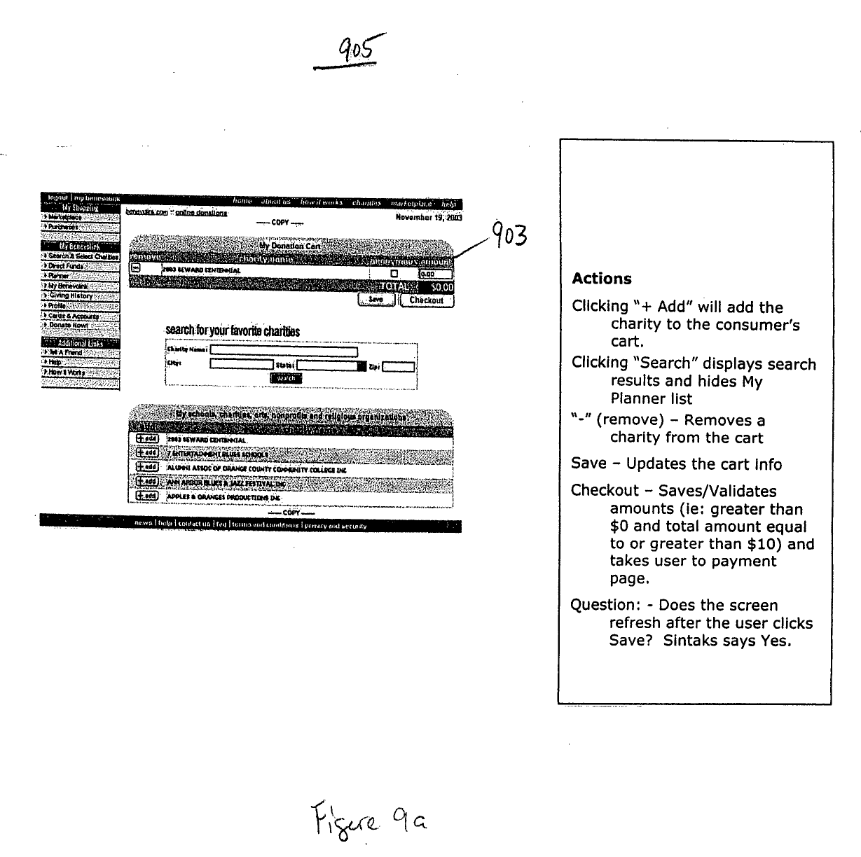

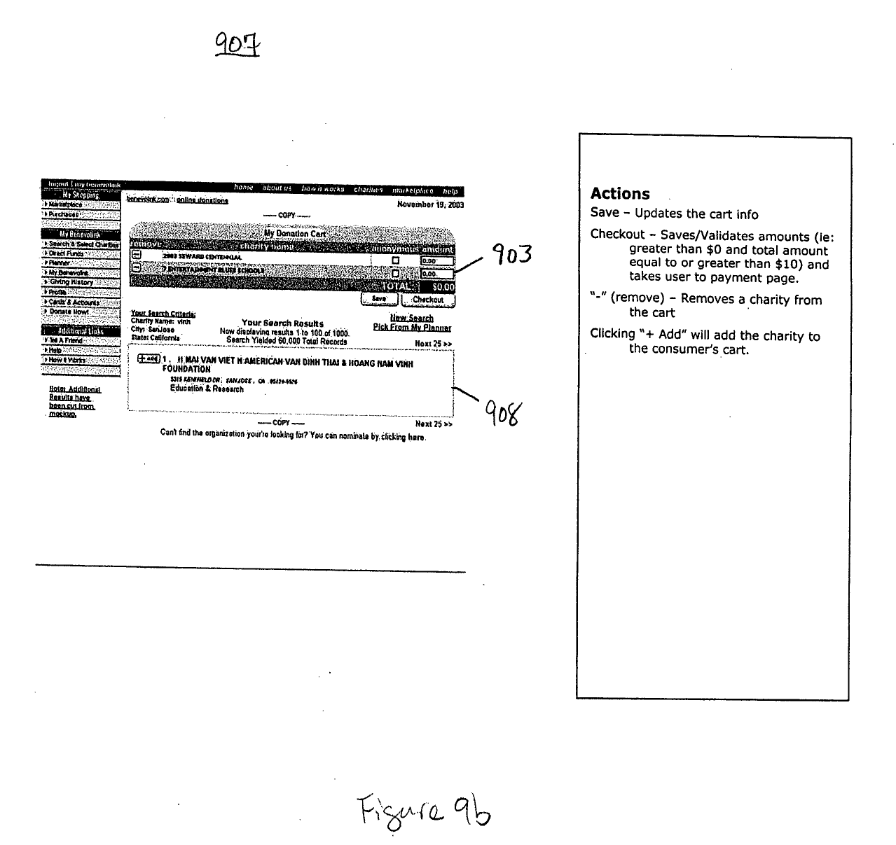

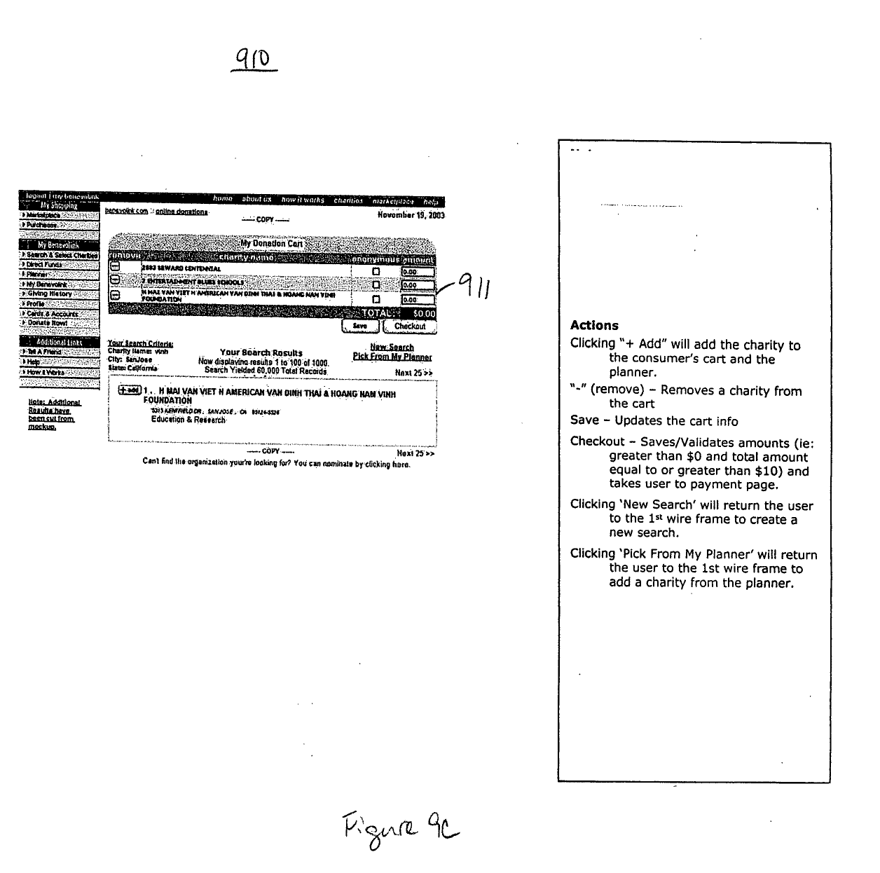

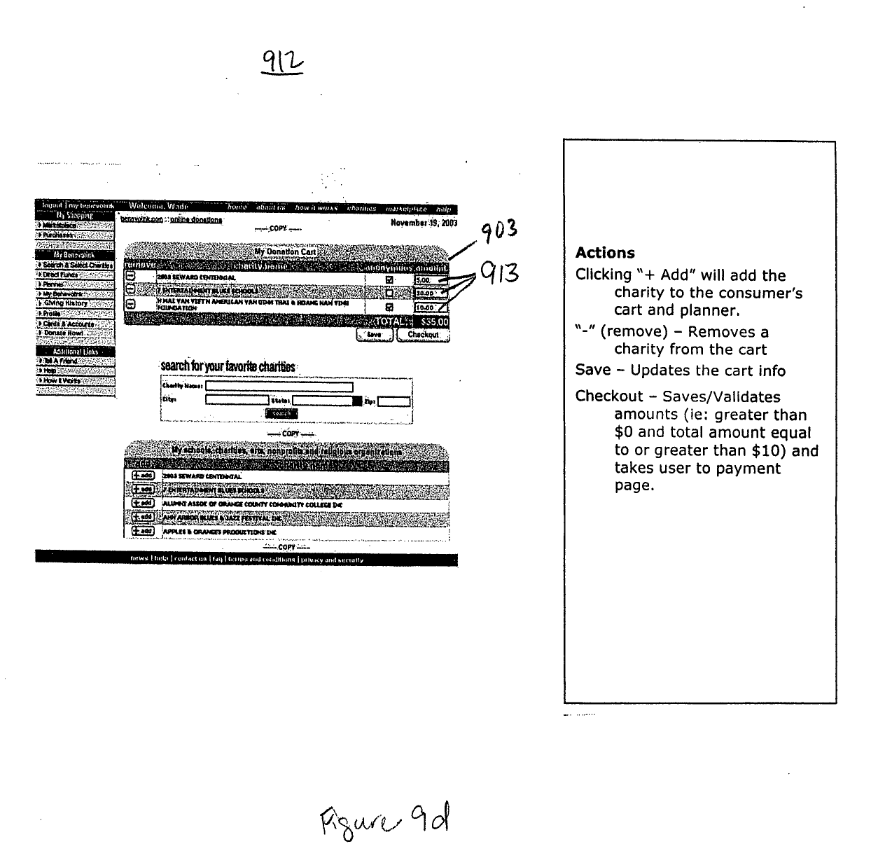

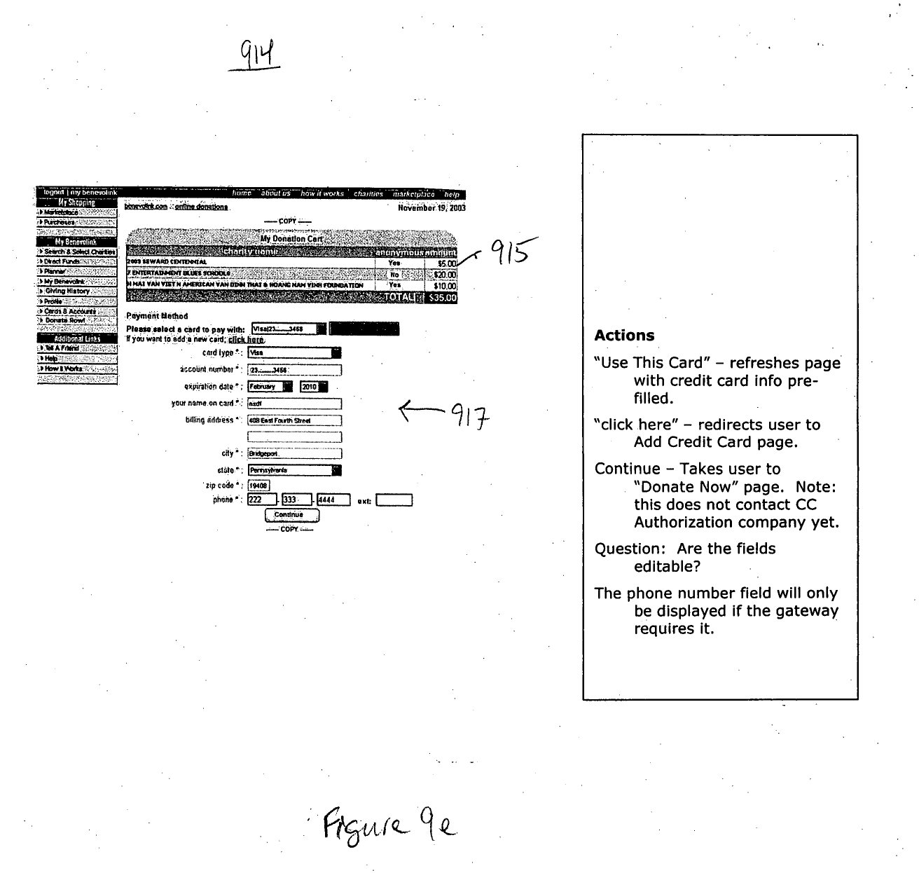

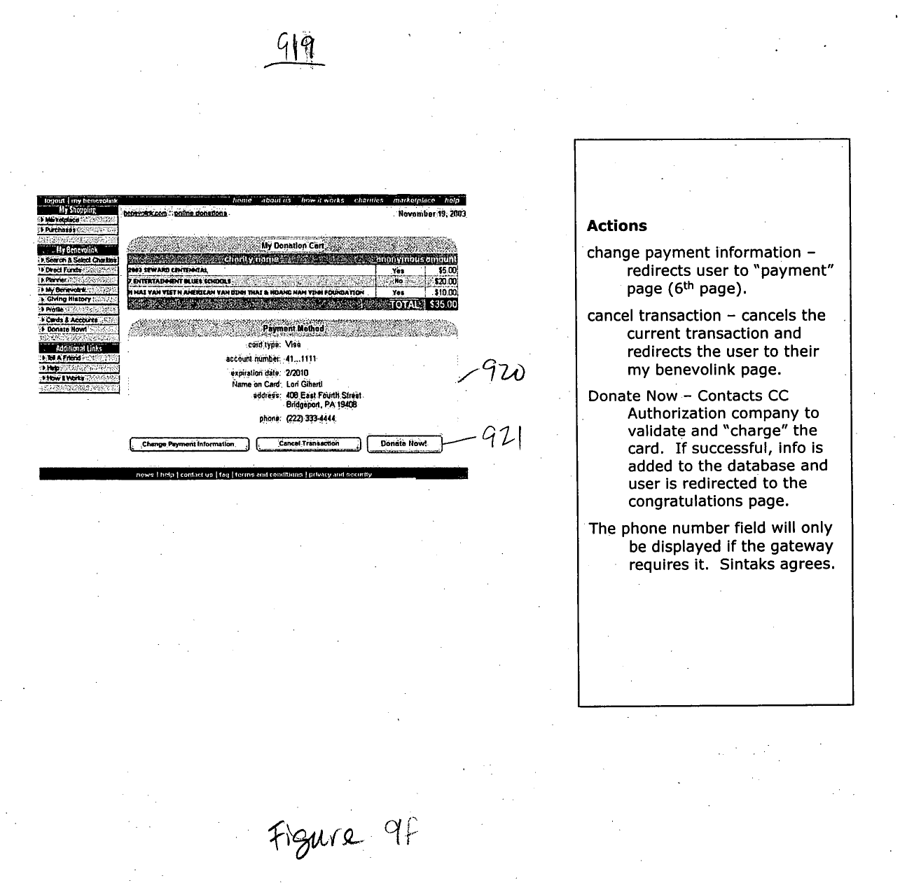

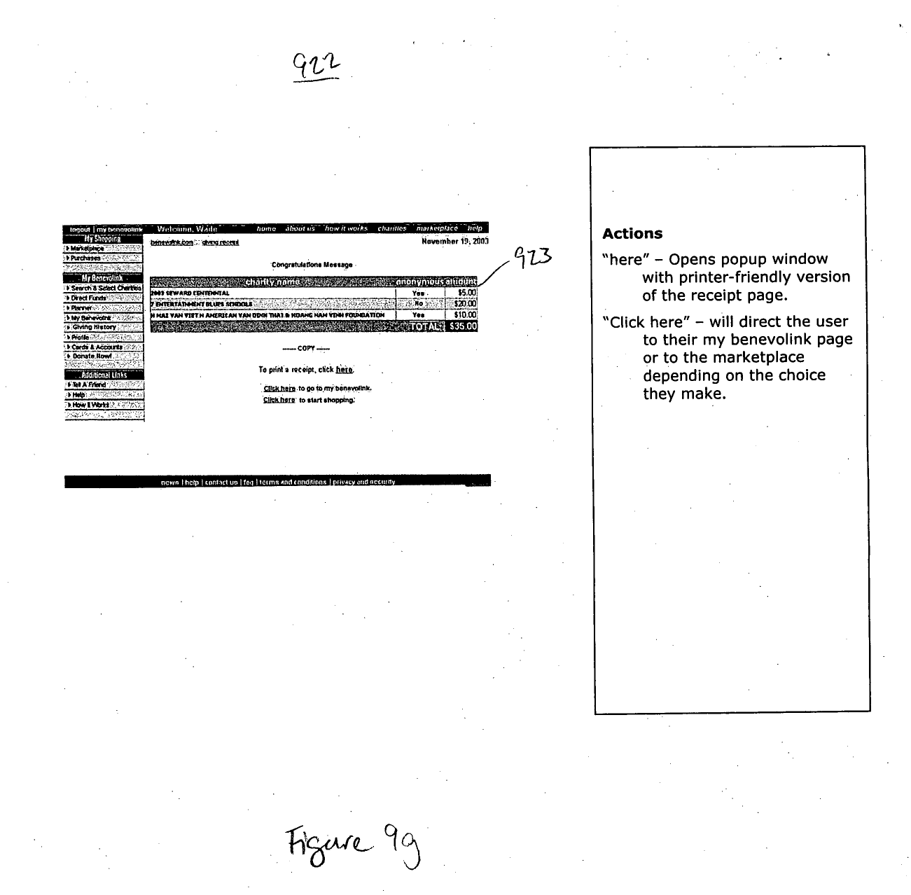

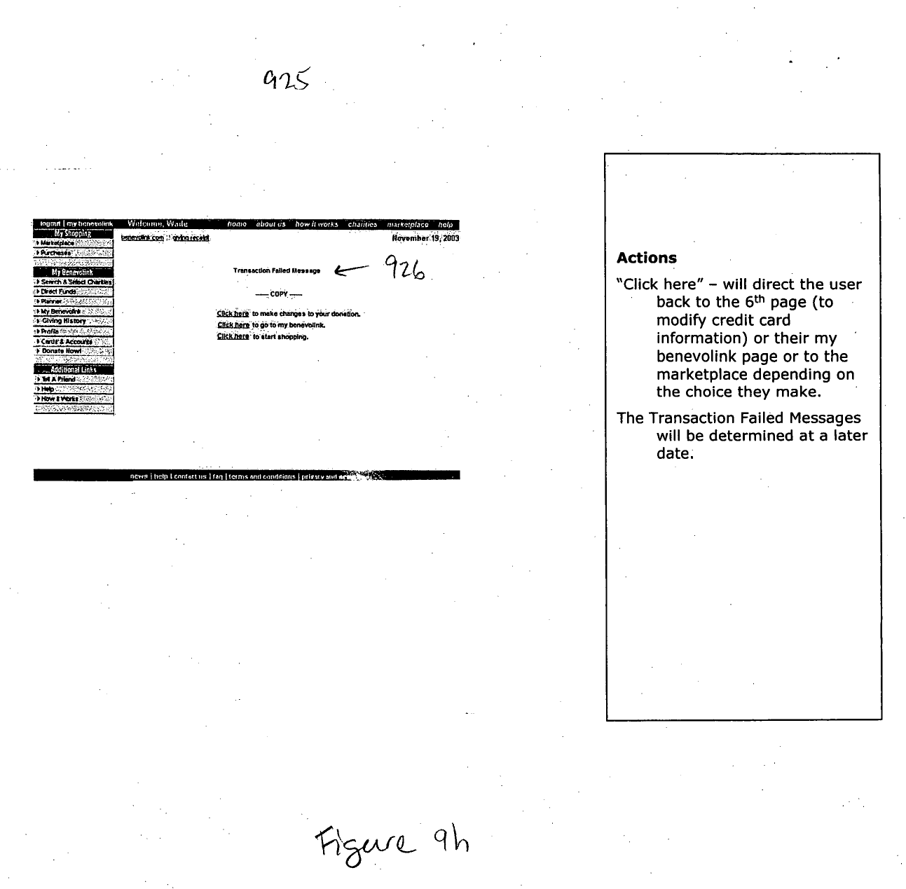

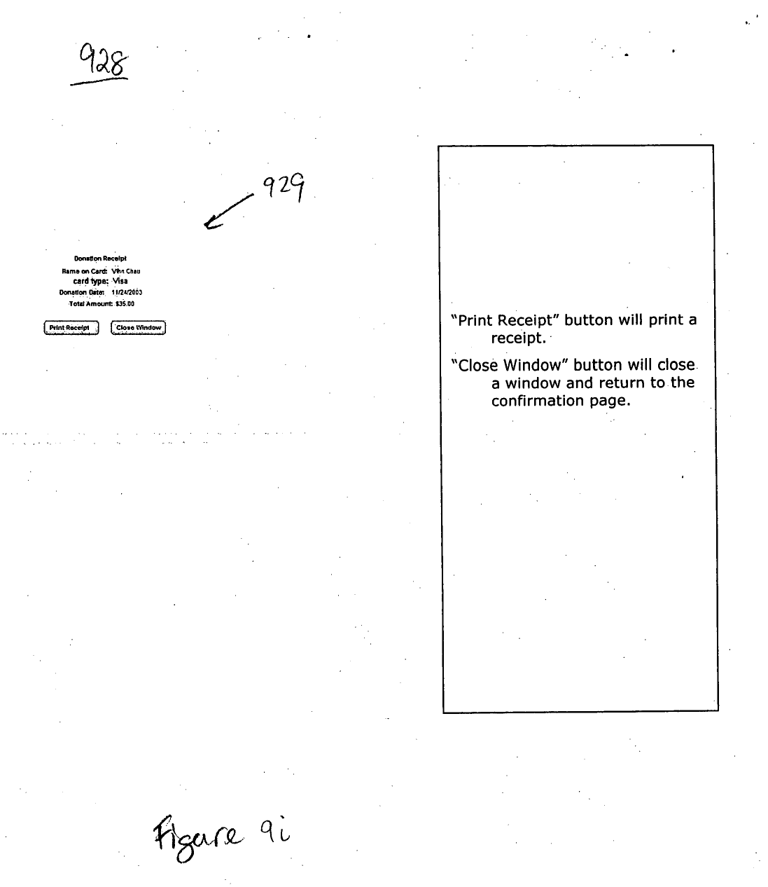

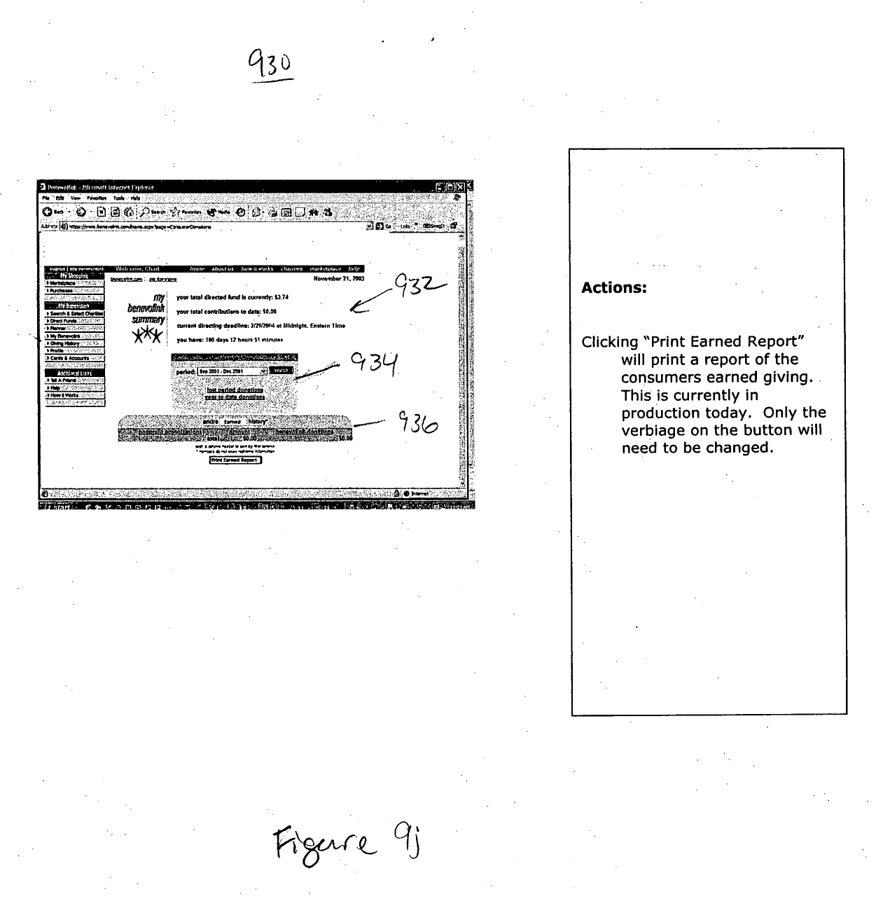

An exemplary embodiment of a web site for the directed giving service provider is illustrated in FIG. 8. Communications (i.e., messages and data files) are transmitted to and from the directed giving service provider web site over a wide area network such as the global Internet 110 which uses standard communications protocols such as the packet-based Transmission Control Protocol/Internet Protocol (TCP/IP) and File Transfer Protocol (FTP). A system firewall 120 within the directed giving service provider web site secures access via network controller 130 to the plurality of web servers 132, 134, 136. An additional firewall 140 limits access to application server 142, email (blaster) server 144, beneficiary check processing device 146 and secure database 150. The secure database contains the program partner, consumer and beneficiary files depicted in FIGS. 1A-1B, 2A-2C and 3 in addition to other data files that are not further described. Communications with program partners 166, registered consumers 164, non-registered users 162 and beneficiaries 168 take place over the Internet 110. Remote access to the DGSP web site is also provided as indicated by DGSP remote access device 160, which typically is a laptop or desktop computer. The DGSP's intranet server 152 can be accessed through system firewall 120 which enables direct access to secure database 150. Also shown in FIG. 8 is a DGSP firewall 180 which provides secure communications to DGSP computing device 184 via router 182. The role of tracker has been described previously, but in FIG. 8 a tracker that is a separate entity from program partners 166 or the DGSP is shown. The dashed lines indicate that the tracker is a separate entity, although that need not be the case. The tracker has its own firewall 170, and pertinent consumer identification and purchase transaction information is sent via router 172 to FTP server 174. Communications between the tracker and the DGSP secure database 150 is through system firewall 120 and FTP server 154. The directed giving software application shown in part in the processing logic of FIG. 4 is resident on application server 142 to perform the directed giving service provider functions depicted in FIGS. 4-6. The software application can also be provided and distributed to others on a mass media device such as a CD-ROM, or transmitted over a wired or wireless communications network.

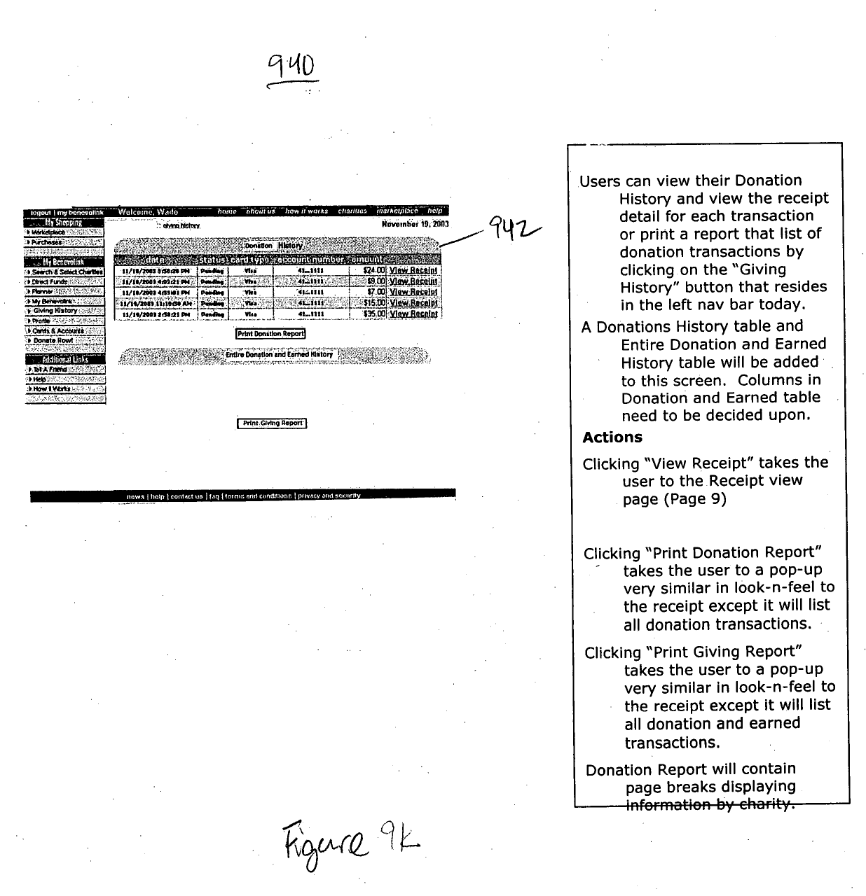

FIGS. 9-9k illustrate various graphical user interfaces (GUIs) which may enable interaction between a consumer and the systems described herein. Other GUIs or interfaces are possible.

FIG. 9 illustrates one embodiment of an interface 900 including a search box 901, a charity list 902, and a donation cart 903. A consumer may interact with interface 900, for example, in order to search for charities he or she wants to contribute to, or to designate particular charities that should receive all or portions of charitable contribution(s). Interface 905 may also include various icons which a consumer may activate to perform or interact with various features and functionality.

FIG. 9a illustrates one embodiment of an interface 905 showing a donation cart 903 containing a particular beneficiary selected by a consumer, for example.

FIG. 9b illustrates one embodiment of an interface 907 showing search results 908 and the addition of another beneficiary to the donation cart 103 by activation of the “+add” icon.

FIG. 9c illustrates one embodiment of an interface 910 showing yet another beneficiary added to donation cart 903 by activation of the “+add” icon in the search results 908.

FIG. 9d illustrates one embodiment of an interface 912 showing various contribution amounts and other information 913 being associated with the various beneficiaries listed in donation cart 903. In some embodiments, other information may comprise whether or not the consumer would like a particular contribution to be anonymous.

FIG. 9e illustrates one embodiment of an interface 914 showing a completed donation cart 915 and a payment method box 917 for permitting the consumer to specify how the specific contributions will be made, for example.

FIG. 9f illustrates one embodiment of an interface 919 showing a confirmed payment method box 920 and various payment icons 921, such as “change payment information,” “cancel transaction,” and “Donate Now!”

FIG. 9g illustrates one embodiment of an interface 922 showing a congratulations message 923 indicating the individual contributions made, and asking whether the consumer would like to print a receipt.

FIG. 9h illustrates one embodiment of an interface 925 indicating that a particular contribution transaction has failed.

FIG. 9i illustrates one embodiment of an interface 928 showing a donation receipt 929.

FIG. 9j illustrates one embodiment of an interface 930 showing a contribution summary 932, a donation period selection box 934, and an entire earned history box 936.

FIG. 9k illustrates one embodiment of an interface 940 showing a giving or contribution history report 942.

Although the present invention has been described in the context of a consumer directed charitable giving program through the aggregation of directing rights generated by purchase decisions made by each of a plurality of registered consumers, the principles are also applicable to employee-directed and shareholder-directed charitable giving using the same processing logic framework, but based on factors other than purchase decisions (e.g., shares owned, employee incentive contracts, seniority, compensation levels, tenure, etc.). A corporate giving program can also involve combinations of consumer-directed, employee-directed and shareholder-directed programs operating in parallel, sequentially or asynchronously (e.g., different purchase periods or different directing rules).

Although the embodiments of the present invention illustrated in FIGS. 4, 5, and 8 have described payments to beneficiary organizations as being paid by the DGSP, payments could also be made directly to beneficiaries through a charitable foundation to which the program partners might make direct payments. The payments through a charitable foundation is the preferred embodiment.

The corresponding structures, materials, acts, and equivalents of any means plus function elements in the claims below are intended to include any structure, material or acts for performing the functions in combination with other claim elements as specifically claimed.

Those skilled in the art will appreciate that many modifications to the exemplary embodiment of the present invention are possible without departing from the spirit and scope of the present invention. In addition, it is possible to use some of the features of the present invention without the corresponding use of the other features. Accordingly, the foregoing description of the exemplary embodiment is provided for the purpose of illustrating the principles of the present invention and not in limitation thereof since the scope of the present invention is defined solely by the appended claims.

What is claimed is:

1. A method for paying charitable contributions, comprising:
determining a first portion of a charitable contribution based on activities of at least one consumer;
receiving from at least one program partner the first portion of the charitable contribution; and
receiving from a first consumer a second portion of the charitable contribution.

2. The method of claim 1 further comprising the step of receiving an instruction from the first consumer to transfer to a second consumer account at least one contribution designating right for designating at least one beneficiary of the first and/or second portion of the charitable contribution.

3. The method of claim 2 further comprising the step of transferring to a second consumer account the at least one contribution designating right for designating at least one beneficiary of the first and/or second portion of the charitable contribution.

4. The method of claim 3 further comprising the step of notifying the first consumer that the at least one contribution designating right has been transferred to the second consumer account.

5. The method of claim 1 further comprising the step of receiving a request from the first consumer directing payment of the first and second portions of the charitable contribution to at least one beneficiary.

6. The method of claim 5 further comprising the step of paying the first and second portions of the charitable contribution to the at least one beneficiary.

7. The method of claim 6 further comprising the step of notifying the first consumer that the first and/or second portion has been paid to the at least one beneficiary.

8. The method of claim 1 wherein the first portion of the charitable contribution is based on at least one of a predetermined percentage of total consumer purchase amounts and a predetermined fixed amount.

9. A system for directing charitable contributions to at least one beneficiary, comprising:
selection means for allowing at least one consumer to select at least one beneficiary;
amount determination means for determining at least one charitable contribution amount to be directed to the selected at least one beneficiary, the at least one charitable contribution amount being based on consumer activities; and
contribution means for allowing the at least one consumer to contribute at least one consumer contribution amount to be directed to at least the at least one beneficiary.

10. The system of claim 9 further comprising payment means for directing, paying and/or donating the charitable contribution amount and/or the at least one consumer contribution to the at least one beneficiary.

11. The system of claim 9 further comprising confirmation means for confirming payment and/or donation of the at least one consumer amount to the at least one beneficiary.

12. A method for donating or transferring charitable contribution directing rights, comprising:
receiving an instruction from a first consumer to transfer to a consumer account for a second consumer certain charitable contribution directing rights earned as a result of at least one consumer's activities, the charitable contribution directing rights comprising rights to direct payment and/or donation of at least one charitable contribution contributed by at least one program partner; and
transferring the charitable contribution direction rights to the second consumer's consumer account.

13. The method of claim 12 further comprising the step of notifying a holder of the consumer account that the charitable contribution direction rights have been received.

14. The method of claim 12 further comprising notifying the first consumer that the charitable contribution directing rights have been transferred.

15. The method of claim 12 further comprising the step of allowing a holder of the consumer account to decide what to do with the charitable contribution directing rights.

16. The method of claim 15 further comprising the step of notifying the first consumer of the disposition of the charitable contribution directing rights by the holder of the consumer account.

17. A system for donating or transferring charitable contributions, comprising:
directing means for receiving an instruction from a first consumer to transfer to a second consumer account certain charitable contribution direction rights earned as a result of at least one consumer's purchase history, the charitable contribution direction rights comprising rights to direct payment and/or donation of at least one charitable contribution contributed by at least one program partner; and
transferring means for transferring the charitable contribution directing rights to the second consumer account.

18. The system of claim 17 further comprising notification means for notifying the holder of a consumer account that charitable contribution rights have been received.

19. The system of claim 17 further comprising confirmation means for confirming transfer to the second consumer.

20. The system of claim 17 wherein the holder of the second consumer account directs the donation and/or transfer of the at least one charitable contribution and/or charitable contribution direction rights.

21. The system of claim 17 wherein the holder of the second consumer account selects at least one beneficiary to receive the charitable contribution.

22. A method for paying charitable contributions, comprising:
providing a first portion of a charitable contribution; and
requesting payment of the first portion and a second portion of the charitable contribution to at least one beneficiary, the second portion being contributed by at least one program partner based on activity of at least one consumer.

23. The method of claim 22 further comprising the step of receiving confirmation that the first and/or second portions of the charitable contribution have been paid.

24. The method of claim 22 wherein the second portion of the charitable contribution comprises funds obtained from at least one consumer.

25. The method of claim 22 wherein the step of directing payment is performed by a consumer.

26. The method of claim 25 wherein the at least one beneficiary is selected by the consumer.

27. A method for paying charitable contributions, comprising:
receiving a first portion of a charitable contribution from at least one program partner, the first portion being based on activity of at least one consumer;
receiving a second portion of the charitable contribution from at least one consumer; and
paying the first portion and second portion of the charitable contribution to at least one beneficiary, the at least one beneficiary being selected by at least one consumer.

28. The method of claim 27 further comprising the step of notifying the at least one consumer that the first and second portions of the charitable contributions have been paid.

29. The method of claim 27 further comprising the step of providing the at least one consumer with a receipt relating to the second portion of the charitable contribution.

30. The method of claim 27 wherein the first and second portions of the charitable contribution are paid to different beneficiaries.

31. The method of claim 30 wherein the first and second portions of the charitable contribution are paid to the same beneficiaries.

32. A method for directing charitable contributions to at least one beneficiary, comprising the steps of:
allowing at least one consumer to select at least one beneficiary;
determining at least one charitable contribution amount to be directed to the selected at least one beneficiary, the at least one charitable contribution amount being based on activity of at least one consumer; and
allowing the at least one consumer to contribute at least one consumer contribution amount to be directed to at least the at least one beneficiary.

33. The method of claim 32 further comprising the step of paying a total charitable contribution amount to at least the at least one beneficiary.

34. The method of claim 33 wherein the total charitable contribution amount comprises the at least one charitable contribution amount and the at least one consumer contribution amount.

35. The method of claim 32 wherein the at least one charitable contribution amount is received from at least one program partner.

36. The method of claim 32 wherein the at least one charitable contribution amount and the at least one consumer contribution amount are directed to different beneficiaries.

37. The method of claim 32 wherein the at least one charitable contribution amount and the at least one consumer contribution amount are directed to the same beneficiaries.

38. A method for making a charitable contribution, comprising:
receiving a request to provide a first portion of a charitable contribution, the first portion being based on activity of at least one consumer; and
providing the first portion to a directed giving service provider, the directed giving service provider paying the first portion to at least one beneficiary along with a second portion of the charitable contribution provider by the at least one consumer.

39. The method of claim 38 wherein the first portion is collected by the directed giving service provider.

40. The method of claim 38 wherein the at least one beneficiary is selected by the at least one consumer.

41. A system for accumulating charitable contributions, comprising:
first portion determination means for determining a first portion of a charitable contribution based on a purchase history of at least one consumer;
program partner reception means for receiving from at least one program partner the first portion of the charitable contribution; and
consumer reception means for receiving from a first consumer a second portion of the charitable contribution.

42. A system for paying charitable contributions, comprising:
provider means for providing a first portion of a charitable contribution; and
directing means for directing payment of the first portion and a second portion of the charitable contribution to at least one beneficiary, the second portion being contributed by at least one program partner based on a purchase history of at least one consumer.

43. A system for paying charitable contributions is provided, comprising:
first portion reception means for receiving a first portion of a charitable contribution from at least one program partner, the first portion being based on a purchase history of at least one consumer;
second portion reception means for receiving a second portion of the charitable contribution from at least one consumer; and
payment means for paying the first portion and second portion of the charitable contribution to at least one beneficiary, the at least one beneficiary being selected by at least one consumer.

44. A system for directing charitable contributions to at least one beneficiary, comprising:
beneficiary selection means for allowing at least one consumer to select at least one beneficiary;
contribution determination means for determining at least one charitable contribution amount to be directed to the selected at least one beneficiary, the at least one charitable contribution amount being based on consumer product purchase information relating to the at least one consumer; and
contribution means for allowing the at least one consumer to contribute at least one consumer contribution amount to be directed to at least the at least one beneficiary.

45. A system for making a charitable contribution, comprising:
request reception means for receiving a request to provide a first portion of a charitable contribution, the first portion being based on the purchase history of at least one consumer; and
provider means for providing the first portion to a directed giving service provider, the directed giving service provider paying the first portion to at least one beneficiary along with a second portion of the charitable contribution provider by the at least one consumer.

46. The method of claim 1 further comprising the step of receiving a third portion from a program partner based on the amount of the second portion, wherein the third portion is a predetermined percentage of the second portion.

47. The method of claim 1 further comprising the step of receiving a third portion from a program partner based on the activities of the at least one consumer.

48. The method of claim 47 wherein the activities of the at least one consumer comprises a purchase of a particular product or service.

49. The method of claim 48 wherein the activities of the at least one consumer comprises a purchase of a product or service from a particular program partner.

50. The method of claim 1 further comprising the step of receiving a third portion from a program partner based on the identity of the recipient of the charitable contribution.
